(19) United States
(12) Patent Application Publication
(10) Pub. No.: US 2014/0111006 A1
(43) Pub. Date: Apr. 24, 2014

(54) ENERGY MANAGEMENT SYSTEM FOR AUXILIARY POWER SOURCE

(71) Applicants: John Baldassarre, Madison, NJ (US); Frank Baldassarre, Berkeley Heights, NJ (US); Isaac Keselman, Florham Park, NJ (US)

(72) Inventors: John Baldassarre, Madison, NJ (US); Frank Baldassarre, Berkeley Heights, NJ (US); Isaac Keselman, Florham Park, NJ (US)

(21) Appl. No.: 13/656,650

(22) Filed: Oct. 19, 2012

(51) Int. Cl. H02J 9/06

(52) U.S. Cl. CPC H02J 9/06
USPC 307/23; 307/38

(57) ABSTRACT

A control system is provided for controlling a load powered by an auxiliary power source during an interruption in the utility power source and/or during a power failure. The control system of the present invention provides power to essential loads in a dwelling as predetermined by a user and/or per the user's real-time instructions as the needs of the user may change. Additionally, the control system of the present invention automatically controls non-essential loads in order to maintain the auxiliary power load below the maximum threshold. Furthermore, the control system of the present invention allows the user to manually override all the controlled loads in an emergency or when the needs of the user change. Additionally, the control system of the present invention allows outside triggers to change the priority of the loads in real-time and can automatically change the priority due to predetermined tasks already running.

### CROSS-REFERENCE TO RELATED APPLICATIONS

This application claims priority to application Ser. No. 61/135,952, filed Jul. 24, 2008.

### FIELD OF THE INVENTION

The present invention generally relates to the technical field of energy management systems, implemented for use with portable or stationary auxiliary power sources such as electric generators, solar power sources, nuclear power sources, etc. More specifically, the present invention relates to a control system and automatic transfer switch apparatus adapted for controlling the total electrical energy consumption of a circuit or group of circuits, which includes a plurality of loads having different current demands, whereby a user controls the power supplied by the auxiliary power source to electrical loads in real-time.

### BACKGROUND OF THE INVENTION

Transfer switches, for use in association with portable or stand-alone electrical generators, are known in the prior art.

A private residence, for example, may normally receive its electrical power from a utility company or a subsidized solar power system. For various reasons, however (location in a region prone to severe weather, etc.), the homeowner may desire a back-up source of electrical power, so that comfort or at least habitability of the residence can be maintained, during periods in which utility power is unavailable.

Typically, a gasoline, diesel, propane or natural gas internal combustion engine-powered electrical generator, capable of generating split-phase alternating voltage, may be installed in or near the residence, and arranged to be connected to one or more of the electrical circuits in the residence in order to provide the desired back-up power.

However, one cannot simply leave the back-up generator permanently connected, in parallel with the utility power, to the residential electrical circuits, nor can one simply connect and power up a back-up generator, without first disconnecting the residential circuits from the power lines coming in from the utility. The reason for this is the possibility that some of the current generated by the back-up generator may inadvertently be back fed into the utility power lines, which may lead to personal injury and/or damage to utility equipment (transformers, etc.).

Transfer switches have been provided to establish the electrical connections between the utility, the residential circuit(s) and the back-up generator. Prior art residential transfer switches typically have been manually actuated devices; known as “break, then make” switches. This means that when the switch is thrown, the connection between the residential circuit(s) and whichever current source is at the time actually connected to the residential circuit, is broken, before the connection is made between the residential circuit, and the current source which is being substituted in.

In a typical situation, utility power fails or falls drastically. The user proceeds to start up the back-up generator, and once appropriate operating speed and voltage have been attained, the user manually throws the switch, to disconnect the utility from the residential circuit, and thereafter, introduce current from the back-up generator.

Prior art manual transfer switches are capable of providing the simple function of serving to safely accomplish the substitution of power sources. However, such prior art manual switches require the presence of the homeowner, in order to accomplish the transfer. This may be undesirable, in that some appliances (e.g., refrigerator or freezer, sump pump, pool heater, etc.) should not go without power for extended periods of time. If a homeowner is absent for an extended period of time (e.g. more than an hour or two), continued power outages may cause potentially serious damage or injury to equipment, property, pets, etc.

Additionally, many businesses use transfer switches for switching power sources, for example, from a public utility source to a private secondary supply, automatically within a matter of seconds. Critical load businesses, such as, hospitals, airport radar towers, high volume data centers, science laboratories, supermarkets, and the like are dependent upon automatic transfer switches to provide continuous power. Transfer switches typically utilize a plurality of contacts that can be open or closed.

Generally, automatic transfer switches are controlled using relay logic, programmable logic controllers (PLCs), embedded controllers, etc. In known systems, the embedded controller monitors the public utility power source for a fault condition. Upon recognizing any one of a number of faults with the utility power, the embedded controller is configured to switch in the secondary source of power, typically a generator, via the transfer switches.

While known electrical systems are able to shed and restore loads according to a user defined predetermined priority list for utility power curtailment and/or peak demand limiting, there does not exist a system that sheds and restores loads coupled to an auxiliary or generator source during an interruption or power failure of the utility power source. Moreover, there does not exist a system that allows the user to update and/or change the priorities of the loads in real-time, as the needs of the user may vary.

Additionally, known systems for utility power curtailment or management of an auxiliary power source do not allow the user to continuously update the priorities of particular electrical loads in real-time, whereby the supply of power to the particular electrical loads is required throughout the completion of a process.

Moreover, known systems for utility power curtailment or management of an auxiliary power source are unable to vary the priorities of the loads according to the user's past history of usage of devices or preferred priority at particular times of year (e.g., the user may tend to utilize different devices more during the summer than during the winter) or even particular times throughout the day (e.g., the user may tend to utilize different devices more during the afternoon than during the evening), whereby these particular preferences can be stored by the system.

It would also be desirable to provide a system that controls an automatic transfer switch, which is capable of starting an auxiliary power source or back-up generator, upon sensing a sustained interruption of utility-supplied electrical power, and disconnecting the utility and connecting the auxiliary power source, when the auxiliary power source is capable of assuming the load.

Accordingly, it would be desirable to provide a control system that is coupled to an auxiliary power source, a main transfer panel, at least one sub-panel and a transfer switch that allows a user to select in real-time which loads are essential, and therefore, should receive power from the backup generator. Additionally, it would be desirable to provide a system that includes a control system that allows a user to continuously modify the priorities of electrical loads in real-time in order to satisfy the needs of the user, while simultaneously maintaining the total usage of power by the user at or just below the maximum capacity of the auxiliary power source, as well as optimally balancing the power supplied to the electrical loads by the auxiliary power source.

Furthermore, it would be desirable to have a control system with a communications interface to enable and select software options from an external device in order to provide user flexibility.

These and other desirable characteristics of the present invention will become apparent in light of the specification, drawings and claims.

### SUMMARY OF THE INVENTION

The present invention overcomes the various deficiencies associated with the prior art by creating a novel control system implemented with an automatic transfer switch and auxiliary power source system and method.

In one non-limiting embodiment, the system of the present invention senses the power output of the generator (i.e., through current, power, or frequency monitoring or a combination thereof) and automatically sheds the loads in a user selected priority if necessary in order to prevent the overload of the auxiliary or generator power source. Additionally, the system of the present invention allows a user to change the priority of the loads in real-time and force any single load to the top of the priority list in real-time. Another non-limiting embodiment will restore a load or loads after a user defined preset time period. Still another embodiment will allow the user to manually restore the loads as more power becomes available from the auxiliary power source.

Moreover, the present invention allows a user to sense the total current to the loads that are in operation and select in real-time which loads should remain in an active and/or operable state as the demand of the loads change, without exceeding the capacity of an auxiliary power source, sometimes referred to as a back-up generator. Additionally, the present invention may allow a user to sense the individual cmTent demand of each load within the system and select in real-time which loads should remain in an active and/or operable state as the demand of the loads change, without exceeding the capacity of the auxiliary power source (e.g., back-up generator). Generally, the control system of the present invention is utilized in connection with an auxiliary power source that is not able to handle all the loads contained within the system.

In one embodiment, the system of the present invention comprises a control system coupled to an electrical system, which is used to sense the current demand of each load individually and/or total current demand. Preferably, the control system comprises a user interactive device, which allows a user to view the status of each load as well as update in real-time the loads that are to be activated and the loads that are to be deactivated via the control system.

In one embodiment of the present invention, a system is provided that comprises a primary or utility power source, an auxiliary or generator power source, an automatic transfer switch, a main breaker panel and a control system. Importantly, the utility power source is preferably provided by a utility power company; however, any source of utility power may be utilized, such as solar power, hydropower, wind power, nuclear power, and the like, without departing from the spirit of the present invention. Additionally, the auxiliary or generator power source, which can be referred to as a backup generator power source, is preferably provided by the user, however, any source of backup power may be utilized, such as solar power, hydropower, wind power, nuclear power, and the like, without limiting the scope of the present invention. Furthermore, both the utility power source and the generator power source of the present invention contain an output.

Moreover, in one embodiment, the automatic transfer switch contains at least two inputs and at least one output, whereby at least one input is coupled to the output of the utility power source and another input of the automatic transfer switch is coupled to the output of the generator power source. The output of the automatic transfer switch is subsequently coupled to the input of a main breaker panel.

Additionally, the control system preferably comprises a microprocessor for continuously sensing the electrical current demand of each load within the system in real-time. Furthermore, the microprocessor contains logic for determining, based on decisions made by a user in real-time, which loads are to be supplied with power, which loads are to be shed from receiving power and which loads are to be subsequently restored at a later time.

In another embodiment of the present invention, a system is provided that comprises a microprocessor. The microprocessor is able to sense when a vital change in the environment occurs, particularly, although not exclusively, when the ambient temperature outside of a dwelling with a heated pool, Jacuzzi, hot-tub, etc. falls below 37 degrees Fahrenheit, when the ambient temperature within a data center rises above 75 degrees Fahrenheit, when the ambient temperature inside a dwelling falls below 32 degrees Fahrenheit, or any other environmental change that may be vital to the existence of the environment or components within the environment. Additionally, if a particular vital change is sensed by the microprocessor, the microprocessor automatically ensures that the load driving a particular device that is necessary to respond to the vital change remains active by amending the priority list to move the affected device to the top of the list in real-time until the environment is restored to a normal or stable condition.

Moreover, if a particular vital change is sensed by the microprocessor, the microprocessor may alert the user via a user interactive device so that the user may shed and restore loads as desired and so that the necessary load remains active while the vital change in environment persists. Furthermore, if the pertinent load for responding to the vital change is not currently active, the microprocessor senses and determines the total demand of all the loads and subsequently determines if activating the pertinent load will overload the generator. If activating the pertinent load will overload the generator, then the predetermined priority list may be implemented by the control system in order to shed less important loads. Additionally, the user is notified and is able to intervene in real-time via a user interactive device, if the user deemed it necessary, which load is to be shed so that the pertinent load can be actuated. Additionally, the user may need to shed a plurality of loads in which case the user continues to choose in real-time which loads are wanted, while the predetermined priority list decides which loads are to be shed until the generator power source can handle the demand of the pertinent load. Importantly, the control system of the present invention is coupled to various types of sensors such as, environmental sensors (e.g., ambient temperature sensors), occupancy sensors to determine if a person has entered a room, vital load sensors to determine if a vital load has been activated, etc. These sensors allow the control system of the present invention to effectively monitor and balance all the components of an electrical system during a utility power failure.

In another non-limiting object of the present invention, the control system can sense when loads are active. Knowing that a load is active, the control system can check the sensor of a particular device when it appears the device is malfunctioning (e.g., when a refrigerator is not staying cold). The control system can then alert the user and test the individual load for the proper current to determine if there is a malfunction in the circuitry within the dwelling or within the device itself, thus leading to efficient resolution when malfunctions occur.

In another non-limiting object of the present invention, the user is given the opportunity to restore loads in real-time as the user chooses so as to satisfy the user's needs, while the control system sheds less important loads, thus optimizing the usage of the generator power source without exceeding the capacity thereof.

In yet another object of the present invention, a user is able to significantly reduce and/or completely eliminate a potential overload of the generator power source, thus significantly reducing and/or eliminating the generator power source from generating excessive heat subsequently reducing and/or eliminating the risk of damaging the infrastructure or equipment, which can prevent the start of fires within the dwelling.

Moreover, it is contemplated that a user may not be at the dwelling when the sensed vital environmental change has occurred. However, a user may predetermine which loads are to be shed if a pertinent load must be in an active state so that the generator power source is not overloaded.

This is done by maintaining the already active load, activating or restoring an inactive load, or in the case where activating the pertinent load would overload the capacity of the generator power source, first shedding as many lower priority loads so that the generator does not become overloaded with the activation of the pertinent load and subsequently activating the pertinent load. Furthermore, the microprocessor may continue to sense all the loads and automatically restore loads and/or activate additional loads as the generator power source becomes able to handle the demands of the additional loads. Importantly, a user may decide in real-time which loads are to be restored or activated or the user may develop a predetermined priority list, whereby loads are shed, restored and activated based on a predetermined priority as decided by the user, based on a predetermined time delay as decided by the user or manually as decided by the user.

In another object of the present invention, a system is provided that sustains a specific active load until the completion of an event. Particularly, this event may include the drilling of oil at an oil excavation site, whereby power must be supplied continuously to the machinery involved in this process until completion. Accordingly, in the event of a power failure the system must ensure power is continuously supplied to the appropriate machinery until the completion of the event. Additionally, this type of system would be effective in hospitals, whereby power must be continuously supplied to equipment in operation rooms. Particularly, although not exclusively, the system of the present invention would be effective in laboratories, data centers, airports and the like, whereby a process that begins must be completed without interruption even if a power failure does occur during the process.

In yet another object of the present invention, a system is provided that is capable of evaluating loads based on a plurality of criteria. Particularly, although not exclusively, a user may evaluate past performance or history of each load (i.e. the current draw of each load per day or per minute), whereby the history includes time of day sensitivity and calendar sensitivity (i.e. based on the month or particular season of the year). Furthermore, each load may be evaluated based on the current power demand of each load in real-time. Preferably, loads that are inconsequential and require a small amount of power are to receive the power necessary to operate and remain active. Moreover, the system of the present invention comprises a user defined overlay, whereby the user defines in a power interruption which loads are to be active and which loads are to be inactive. Accordingly, the user does not need to establish a predetermined priority list or preset timers to maintain the balance of power distributed to the loads. Conversely, the user can balance the power distributed to the loads in real-time in accordance with the current needs of the user while optimizing the utilization of the generator power source.

In another object of the present invention, a control system is provided that is able to activate and deactivate any load contained within the system.

Other objects, features, and characteristics of the present invention, as well as the methods of operation and functions of the related elements of the structure, and the combination of parts and economies of manufacture, will become more apparent upon consideration of the detailed description below, all of which form a part of this specification.

### BRIEF DESCRIPTION OF THE DRAWINGS

A further understanding of the present invention can be obtained by reference to preferred embodiments and corresponding alternate embodiments as set forth in the illustrations of the accompanying drawings. Although the illustrated embodiments are merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the present invention, reference is now made to the following drawings in which:

FIG. 1 illustrates a schematic diagram of the system in accordance with the present invention.

FIG. 2 illustrates a schematic diagram of the components of control system 114 as shown in FIG. 1 in accordance with the present invention.

FIG. 3 illustrates a front view of a user interactive device in accordance with the present invention.

FIG. 4 is a flow chart illustrating the method in which the microprocessor responds to an interruption in the power supplied by the utility power source in accordance with an embodiment of the present invention.

FIG. 5 is a flow chart illustrating the method in which the microprocessor, in conjunction with user interaction, responds to an interruption in the power supplied by the utility power source, whereby the generator power source may not be capable of handling all the loads in accordance with an embodiment of the present invention.

FIG. 6 is a flow chart illustrating the method in which the microprocessor responds to an interruption in the power supplied by the utility power source, whereby the microprocessor senses a vital change in the environment in accordance with an embodiment of the present invention.

FIG. 7 is a flow chart illustrating the method in which the microprocessor responds when a process has commenced that must be completed without interruption in accordance with an embodiment of the present invention.

### DETAILED DESCRIPTION OF THE PREFERRED EMBODIMENTS

Detailed illustrative embodiments of the present invention are disclosed herein. However, techniques, systems, and operating structures in accordance with the present invention may be embodied in a wide variety of forms and modes, some of which may be quite different from those in the disclosed embodiments. Consequently, the specific structural and functional details disclosed herein are merely representative, yet in that regard, they are deemed to afford the best embodiments for the purposes of disclosure and to provide a basis for the claims herein, which define the scope of the present invention. The following presents a detailed description of preferred embodiments (as well as some alternative embodiments) of the present invention.

A further understanding of the present invention can be obtained by reference to a preferred embodiment. Although the illustrated embodiment is merely exemplary of systems for carrying out the present invention, both the organization and method of operation of the invention, in general, together with further objectives and advantages thereof, may be more easily understood by reference to the following description. The description is not intended to limit the scope of this invention, but merely to clarify and exemplify the invention.

Moreover, well known methods, procedures, and substances for both carrying out the objectives of the present invention and illustrating the preferred embodiment are incorporated herein but have not been described in detail as not to unnecessarily obscure novel aspects of the present invention.

The terms used herein, including “user,” “individual” and “person” are not meant to limit the scope of the invention to one type of entity, as any entity or individual can also utilize the present invention.

Additionally, the terms used herein, including “load,” “circuit,” and the like are used interchangeably and are not meant to limit the scope of the present invention.

Furthermore, the terms used herein, including “auxiliary power source,” “secondary power source,” “generator power source” and the like are used interchangeably and are not meant to limit the scope of the present invention. It should also be appreciated that the system of the present invention generally discloses the use of generator power source, however, any type of power source (e.g., solar power, nuclear power, etc.) can be implemented by the system of the present invention.

Preferably, in the event of a primary or utility power failure or power outage, the control system of the present invention is capable of detecting the event and automatically monitors and/or balances the power distribution of an auxiliary or generator power source. Furthermore, in the event that the auxiliary or generator power source does not start-up during a utility power failure or outage, the control system is capable of notifying the user via transmission of a text message to the user's cellular telephone, an electronic mail to the user or any other method for communicating this urgent condition to the user.

Additionally, the control system of the present invention minimizes power consumption because the control system controls the dwelling's power demand for the user by automatically shedding unnecessary loads and/or allowing the user to choose in real-time which loads are to be shed. Moreover, the control system of the present invention allows the user to have a smaller than usual generator because the user only needs a generator that is able to handle the loads the user wants to have activated. Preferably, the control system of the present invention is designed so that not every load in the dwelling is active during a power outage or interruption. Furthermore, a user can connect all the loads within the dwelling to the generator power source and then have the control system shed and restore loads as desired by the user. Thus, the control system of the present invention improves the typical load distribution back-up systems, where only a sub-panel of predetermined loads receives power in the user's dwelling during a power failure and/or outage.

Since the control system of the present invention allows the implementation of a generally smaller auxiliary or back-up generator, the user in turn is able to save on the consumption of fuel needed to generate power for the generator. By installing and utilizing a smaller generator, the user is able to conserve on natural resources (e.g., oil) required to run the generator as well as to maintain the generator. Moreover, smaller generators generally allow for fewer parts, thus fewer parts to replace and dispose of during routine maintenance and/or malfunctions.

The control system of the present invention is preferably customized for the circuits contained in a user's dwelling, whereby circuits are shed and/or restored automatically or by a user in real-time. Preferably, the control system of the present invention brings power to the essential loads in the dwelling (e.g. water supply, refrigeration, heating, sump pumps, lighting, telephones, etc.) and automatically controls non-essential loads (e.g. secondary heating and pumping, non-essential air conditioning and lighting, Jacuzzi, steam, etc.) to maintain the generator power source at an acceptable level. Moreover, the control system of the present invention provides a manual override in order to allow the user to control loads in an emergency or as the needs of the user change. The user is able to override the loads via the use of an interactive device, which contains a graphical display that shows the user the generator's current usage.

Preferably, the control system of the present invention controls how the power is distributed from the auxiliary power source. The control system continuously monitors the auxiliary power source (e.g., back-up generator) and adjusts the dwelling's circuits to allow maximum usage of the generator. If the total load exceeds allowable generator power, the control system automatically sheds circuits, maintaining generator peak usage and performance. The control system restores circuits as the dwelling's loads decrease. Additionally, the control system may use a priority list of loads that automatically activate during an outage. However, the user may decide in real-time which loads are to be active during a power outage. If there is sufficient generator power available from the generator, then all the priority loads will turn on. The priority list may be customized to the user's needs and allows the user to decide which loads will come on in what order. Conversely, a user may activate and deactivate loads in real-time based on current needs.

In accordance with the present invention, an energy management system is provided for automatically limiting the total instantaneous consumption of electrical energy in a residence having a plurality of energy consuming loads with different current demands, while maintaining the consumption level as high as possible without exceeding a predetermined peak total current demand and/or overloading the auxiliary or generator power source during an interruption in the utility power source and/or a power failure. It is contemplated that an interruption of primary or utility power may be considered anytime the power drops below a standard set in the program with regards to voltage, sine wave, Hertz, and/or any other means known in the art. Additionally, once the control system detects that the primary or utility power source has been restored and is performing at an acceptable level, the loads are switched back to the primary power source via the control system or an automatic transfer switch as known in the art.

Preferably, the control system comprises sensor means for measuring the total current to the loads which are then in operation and current interruption means for automatically interrupting the current, if any, to each of the loads in a predetermined sequence or as defined by a user in real-time via a user interactive device, when the total current to the loads then in operation exceeds the predetermined peak demand and/or the total capacity of the generator power source. Preferably, loads are shed in the predetermined sequence established by a user and/or as defined by a user in real-time via a user interactive device until the total current is less than the predetermined peak total or until the system has detected a stable current situation. Means are provided for selecting from among those loads which have been interrupted, the loads which can be restored without causing the total current to exceed the generator power source's maximum threshold and for automatically restoring the selected loads to operation in a predetermined sequence or as defined by a user in real-time via a user interactive device. Additionally, the control system of the present invention may sense the current demand in each load individually as well as total current demand of all the loads.

While the control system of the present invention may sense the current of the loads of the auxiliary power source, the control system may sense the power through other means as well, such as, power and frequency monitors, 60 Hertz cycles, sine waves, to etc. to determine when the auxiliary power source is overloaded.

In a preferred embodiment of the present invention, the control system manages loads based on three threshold levels of the auxiliary power source. The control system of the present invention preferably begins to shed loads from the auxiliary power source when approximately 80% of the auxiliary power source is being consumed. Subsequently, the control system of the present invention preferably begins to restore loads to the auxiliary power source when approximately 65% of the auxiliary power source is being consumed. Additionally, as a precautionary measure to avoid an overload of the auxiliary power source, if 95% of the auxiliary power source is being consumed the control system sheds all the loads from the auxiliary power source. Once all the loads are shed from the auxiliary power source, the control system preferably begins to restore the loads to the auxiliary power source. While specific threshold values were described above, it should be appreciated that any appropriate threshold values may be implemented without departing from the spirit of the invention.

In a further embodiment of the invention, means are also provided for periodically re-measuring the total current and restoring an additional load to operation if the current demand thereof, added to the demands of the loads then in operation, does not exceed the generator power source's middle and/or maximum threshold.

In the preferred embodiment of the invention, the loads are restored sequentially in a predetermined sequence and/or as defined by a user in real-time via a user interactive device, if possible, without exceeding the generator power source's middle and/or maximum threshold.

Moreover, a user's environment is dynamic. As such, the priority of each load may change throughout the course of time. Thus, the user might consider that celiain electrical loads should take priority over others at certain times. However, the user might need to update or modify the priorities of particular electrical loads in real-time as the user's needs change. As such, the user must be able to modify the priority of the loads in real-time in order to accommodate the current needs of the user while maintaining the total amount of power consumed at or below the available supply.

Furthermore, there are instances or situations whereupon once a particular activity commences it must be completed. Hence, the power supplied to the equipment performing the particular activity must be continuously supplied throughout the process. Consequently, upon an interruption of power or a power failure, a user must be able to maintain power to the equipment essential for completion of the task or event. More importantly, the user must be able to change or update the priorities of each electrical load in real-time.

For example, once the process of drilling for oil commences, it must be completed. Hence, the power supplied to the equipment must remain continuous throughout the process. Consequently, upon an interruption of power or a power failure, a user must be able to maintain power to the equipment essential for completion of the particular task. Similar situations arise in hospitals, airport radar towers, high volume data centers, science laboratories, and the like.

Furthermore, a disabled person (i.e. a person confined to a wheelchair) may have an elevator in his/her dwelling, whereby in the case of an interruption in the utility power source, the user requires that the elevator remain active. Moreover, a person with a chronic disease that requires the person to be constantly medicated via electronic medical equipment or necessitates a certain living condition, which requires that the medical equipment or the necessary equipment to maintain a certain living condition remain powered on even in the event of an interruption in power from a utility power source. Accordingly, it is crucial to allow a user to control the loads within a system in real-time via the use of a user interactive device. It is appreciated that the system of the present invention could benefit any type of situation in which a particular device must remain activated during a utility power source failure.

Importantly, the control system of the present invention is coupled to various types of sensors such as, environmental sensors (e.g., ambient temperature sensors), occupancy sensors to determine if a person has entered a room, vital load sensors to determine if a vital load has been activated, etc. These sensors allow the control system of the present invention to effectively monitor and balance all the components of an electrical system during a utility power failure.

It is contemplated that the control system of the present invention can utilize occupancy sensors in a manner that would allow the lights as well as various other loads that control devices within a room to activate when a user enters that particular room of a dwelling. Accordingly, as a user moves about the dwelling the occupancy sensors sense the user leaving one room and subsequently sheds the loads to the devices in that room, while it activates the loads in the room that the user is currently occupying. Thus, the control system is able to efficiently distribute the power to the loads as needed by the user without wasting the limited power supply of the auxiliary power source.

As previously mentioned, a user's environment is dynamic. As such, the priority of each load may change throughout the course of time. For example, if the temperature outside drops below a certain level (e.g. 37 degrees Fahrenheit) during an interruption of power or a power failure, the user might want to actuate the Jacuzzi or pool heater so that the pipes do not freeze. Thus, the user might consider that operating the Jacuzzi or pool heater in order to avoid frozen pipes should now take priority over providing power to an electrical load of lower priority (e.g. the lights in the basement of the home) as deemed by the user. As such, the user can alter the priority of the load in real-time in order to accommodate the current needs of the user while maintaining the total amount of power consumed at or below the available supply.

Furthermore, the control system of the present invention could be used to implement various methods to efficiently control an air conditioning system that contains multiple air conditioning units. Preferably, a user may first designate the priority of each air conditioning unit (e.g., designate which air conditioning unit should turn on first, which air conditioning unit should stay on the longest, etc.). Once the priority of each air conditioning unit has been designated for each air conditioning unit, the control system is able to continuously cycle through the air conditioning units, whereby each air conditioning unit periodically turns on while the remaining air conditioning units remain deactivated according to a predetermined priority.

Generally, when a user designates priority to multiple air conditioning units, it is assumed that the user would most likely desire the top priority air conditioning unit to maintain the longest run time. However, a user may want to change the priorities of the air conditioning units in real-time as certain situations in the environment change or simply because the user's preferences have changed or may want the control system to do this automatically for them. For example, during a summer day, the user may want the air conditioning unit that cools the lower level of the dwelling to run on a forty-five minute cycle, while the user may only desire the air conditioning unit that cools the upper level of a dwelling to run on a fifteen minute cycle. However, when it is nighttime, the user may want the roles of these two air conditioning units to be switched, whereby the control system of the present invention would be able to implement the user's change in preference.

Moreover, it could be contemplated that a particular air conditioning unit activates upon sensing a person in a particular part of the dwelling, whereby the air conditioning unit that activates is the air conditioning unit that is used to cool that same part of the dwelling. Notably, the control system can activate and deactivate each air conditioning unit on a continuous cycle based on a predetermined priority as set by the user, can cycle each air conditioning unit in a continuous yet random order, allow the user to override the predetermine priority and activate the air conditioning unit that is preferred at that particular moment and deactivate the one that is not needed and/or can activate additional air conditioning units as long as the activation of the additional air conditioning unit does not result in exceeding the middle and/or maximum threshold level of the auxiliary or secondary power source. It should be contemplated that there may be various ways to cycle air conditioning units without departing from the spirit of the present invention.

Additionally, the present invention may be implemented through a local area network and/or via the Internet, thus allowing a user to manage the control system remotely with a variety of independent interactive devices (e.g. a computer, a personal digital assistant, a cellular telephone, etc.). Having access to the control system of the present invention via the Internet, allows the user to activate/deactivate loads remotely as desired as well as monitor the status of the overall electrical system. For example, while on vacation or away from the dwelling for an extended period of time, a user can monitor the electrical system to ensure all pertinent loads (e.g., refrigerator, sump pump, etc.) remain active. Subsequently, if the user determines that a pertinent load is inactive, the user may instruct the control system to activate the load. Furthermore, a user can preferably shed loads remotely as desired.

Moreover, it could be contemplated that in the case where there are multiple air conditioning units in a residence or business complex, e.g. 5, 6 or 10, and the current load demand on the auxiliary power source allows more than one air conditioning unit to be on at one time, then if a particular air conditioning unit is deemed the highest priority unit for that given time as such it will activate and stay activated. The remaining air conditioning units will then cycle on a predetermined time basis to maintain a sufficient temperature in all the other locations of the building. As the highest priority unit can change over time or based on a given time of day, whereby during the daytime the highest priority unit could be the main floor unit and during the nighttime the highest priority unit could be the upper floor or bedroom unit. Preferably, the system can automatically change the highest priority unit for a different time period and then cycle the remaining units to maintain a sufficient temperature in all other locations of the dwelling or business complex. Additionally, the control system can use sensors to monitor comfort levels and cycle air conditioning units based on preset comf011levels as well as allow more priority units to turn on based on the available power in the auxiliary or generator power source, e.g. keep on 2, 3 or 4 units. Thus cycling of the remaining air conditioning units that are not deemed high priority units can be accomplished on a time basis or with sensor feedback from the environment. Any combination of these high priority units and cycling units can be accomplished and handled automatically by the control system of the present invention. Each combination is not listed here but understood and should not limit the spirit of the present invention.

Load-shedding devices which limit power consumption in residences, places of business and manufacturing plants are well known in the art. Such load-shedding devices usually consist of a sensor or sensors for measuring total energy consumption of a residence or the like and means such as relays for shedding loads in a predetermined sequence when the demand exceeds the predetermined peak demand. Restoration of the loads may be automatic or manual. However, until now, no energy management system has been devised which will shed and/or restore a load based upon a user's current needs as determined by a user in real-time, or as determined intuitively by the control system of the present invention based on actual preferences demonstrated by the user's past activity in similar situations (e.g. time of year, time of the day, etc.). Additionally, the system of the present invention preferably senses the demand of each load or the total demand of all the loads before allowing the user to restore an inactive load so that the threshold level of the secondary power source is not exceeded.

It is contemplated that the control system of the present invention is able to sense the demand on every load as well as sense the usage of each load on a daily basis. Particularly, a user may evaluate past performance or the history of each load (i.e. the draw of each load per day or per minute), whereby the history includes time of day sensitivity and calendar sensitivity (i.e. based on the month, particular season of the year, and/or any relevant time period). Furthermore, the control system can store this information and statistically translate it to determine the priority of each sensed load, and subsequently create a priority list to be implemented by an auxiliary power source in the instance when the utility power source fails. Preferably, the control system is able to distinguish the time of day and the time of year, where the preferences of a user could be dramatically different, and apply the appropriate priority list, which is preferably stored by the control system, according to the cut Tent circumstances. Subsequently, the control system of the present invention is able to more efficiently utilize the auxiliary power system, without exceeding its capacity, and while meeting the needs of the user.

Moreover, the control system of the present invention controls the restoration of loads. Although the system of the present invention generally restores loads in accordance to a user's current needs and/or in accordance to a user's predetermined priority list, it should be noted that the system is able restore a load or multiple loads out of sequence only if the restoration of a particular load will not exceed the threshold of the auxiliary power source. Thus, the control system of the present invention is able to prevent the auxiliary power source from exceeding its capacity, while optimizing the total power supplied by the auxiliary power source to the user.

Without departing from the spirit of the present invention, it is contemplated that instead of sensing the demand of each load, a user may arbitrarily assign a specific demand to each load, until the system is able to calculate the actual demand required by each load contained within the system. In this situation, when a load is shed, the control system measures the value of the load that was just shed by subtracting the current total load demand from the previous total load demand. Once the load demand for a load is calculated it is stored and used in the future when the system is attempting to determine which loads need to be shed and which can be restored.

Accordingly, the system of the present invention senses an interruption in the power supplied by the utility power source and determines if the generator power source is capable of supplying power to every currently active load in the system. If the generator power source cannot supply power to every active load, the user is able to decide in real-time which loads to shed so that the generator power source is not overloaded. Subsequently, the system of the present invention continuously senses the demand of each load and allows the user to choose which loads to shed, to restore and/or are to remain active in real-time and via the use of an interactive device so that the needs of the user are met.

It is also contemplated that a solar power source may be used during a primary or utility power outage or interruption. Generally, utilizing solar power as a secondary power source would be beneficial particularly when a dwelling is not occupied and thus many of the loads are not required to be active. Furthermore, it is contemplated that solar power source could supplement the traditional generator power source in order to conserve natural resources, whereby the control system of the present invention can control the solar power source to satisfy the low energy requirements (e.g., nightlights, refrigerator, sump pump, heat to pipes, etc.) of a dwelling, particularly if the dwelling is not occupied at the time of the power outage. Thus, the generator power source would not have to be active during every power outage. However, once the load increases above the ability of the solar power source the generator power source would start up and subsequently supply power to the loads. Additionally, if the demand of the load decreases, the generator power source would turn off and the solar power source would once again supply power to the loads.

Conceivably, the system of the present invention, which has the ability to limit any major surges in power that could overload the auxiliary or generator power source could also be used to limit the peak demand from the power company, thus allowing the existing power grid to handle the additional loads that are presented from greater sizes of residences and/or additional power consuming devices such as, appliances, gaming systems, TVs, lighting, etc. Additionally, during peak demand hours, or situations of deliberate voltage reduction (e.g., utility power curtailment) by the power company the system of the present invention can sense these circumstances and become active, which would allow a user to regulate and limit the consumption of power as well as maintain loads in accordance to the user's current preferences, thus distributing power evenly across the phases and avoiding major peak demands.

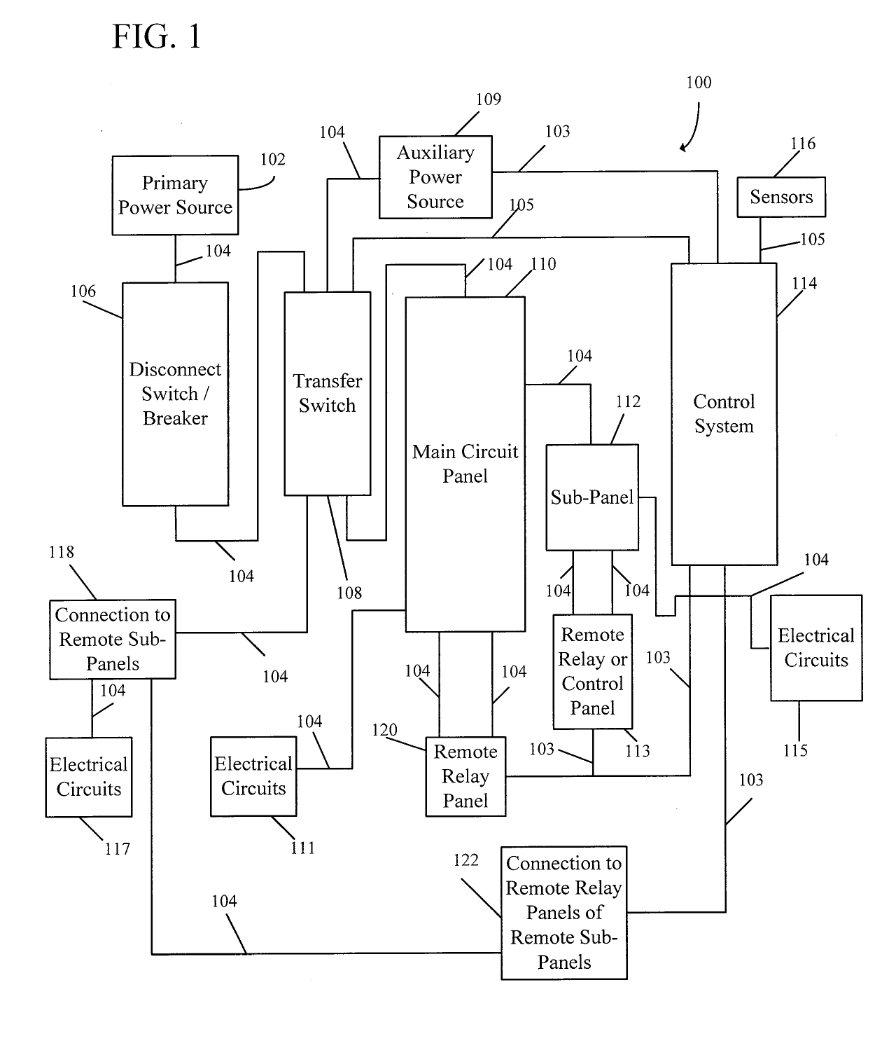

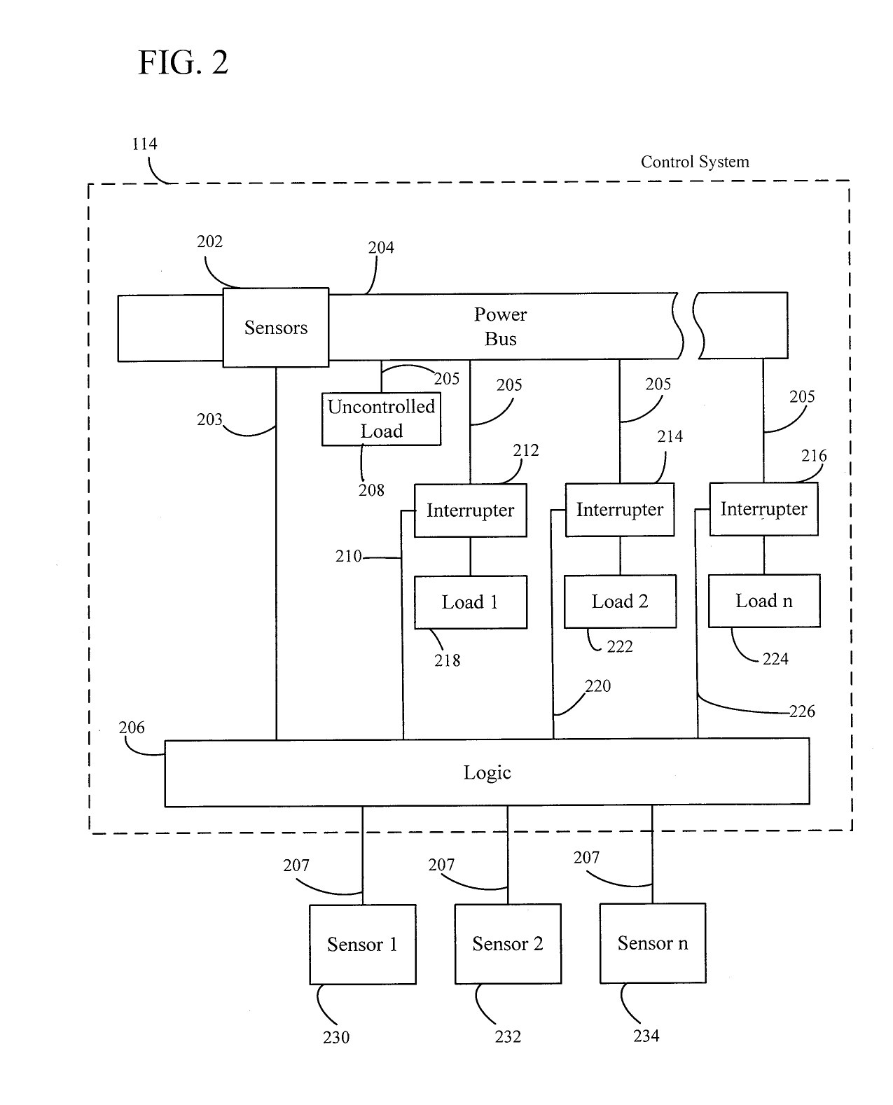

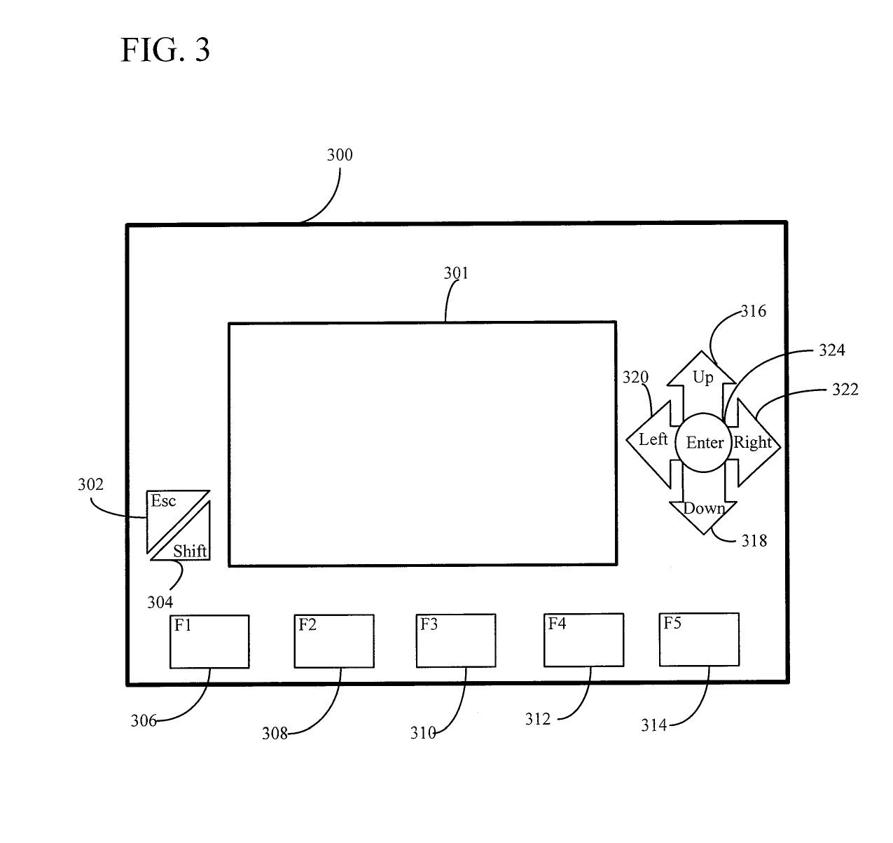

Referring to the drawings, wherein like numerals indicate like elements throughout, FIG. 1 illustrates the components of the system in accordance with the present invention; FIG. 2 illustrates a schematic diagram of a control system 114 as shown in FIG. 1 in accordance with the present invention; and FIG. 3 illustrates a front view of a user interactive device 300 used for controlling control system 114 of FIGS. 1 and 2 in accordance with the present invention.

As shown in FIG. 1, the electrical system 100 of the present invention comprises a primary or utility power source 102 coupled via electrical or feeder wire 104. Preferably electrical system 100 may comprise a disconnect switch/breaker 106, a transfer switch 108, a main circuit panel 110, a sub-panel 112, a control system 114, and an auxiliary or secondary power source 109. Preferably, disconnect switch/breaker 106, transfer switch 108, main circuit panel 110, and sub-panel 112 may be components that are commonly known in the art as implemented within electrical systems of a dwelling or building. Thus, any device as commonly known in the art may be used to implement the function of each respective component without limiting the scope of the invention.

Preferably, main circuit panel 110 and sub-panel 112 contain switches that are coupled to loads or electrical circuits 111 and 115 via electrical wires 104, respectively, which are coupled to various devices throughout a dwelling, such as appliances (i.e., air conditioner, heater, washing machine, etc.), outlets, switches, and the like. As commonly known in the art, a user may activate and deactivate electrical circuits 111 and 115 by flipping particular switches contained within main circuit panel 110 and sub-panel 112, thereby activating or deactivating the particular specified appliance, device, outlet, switch, etc. Preferably, sub-panel 112 is coupled to main circuit panel 110 via electrical wire 104. Furthermore, transfer switch 108 or main circuit panel 110 may be coupled to at least one or more remote sub-panels 118 via electrical wire 104. Generally, remote sub-panel 118 can be located anywhere within the dwelling and is comprised of similar elements as sub-panel 112. Additionally, remote sub-panel 118 performs similar functions as sub-panel 112, however, remote sub-panel 118 controls electrical circuits 117 within the dwelling via electrical wire 104. Moreover, as with sub-panel 112, remote sub-panel 118 may be any component that is commonly known in the art as implemented within electrical systems of a dwelling or building.

Furthermore, as many loads or electrical circuits as necessary to prevent overload of the auxiliary power source or generator contained within main circuit panel 110, sub-panel 112, and remote sub-panel 118 are connected to relays (not shown) via wire 104 contained within relay panels 120, 113, and 122 respectively. Preferably, relay panels 120, 113, and 122 contain relays (not shown) coupled to as many electrical circuits as necessary to prevent overload of the auxiliary power source or generator contained within the specific panel. Moreover, relay panels 120, 113, and 122 may be located within main circuit panel 110, sub-panel 112, and remote sub-panel 118, respectively, or may be located remotely as shown in FIG. 1 via electrical wires 104. These relay panels will be described in more detail below in conjunction with the description of control system 114. Generally, as many loads as necessary to prevent overload of the auxiliary power source or generator contained within any sub-panel, remote or local, that may be contained within electrical system 100 are connected to a relay.

Control system 114 may be coupled to auxiliary power source 109 via control wire 103, transfer switch 108 via sensor wire 105, at least one sensor 116 via sensor wire 105, main circuit panel 110 via control wire 103 and relay panel 120, sub-panel 112 via control wire 103 and relay panel 113, and to at least one remote sub-panel (not shown) via control wire 103 and a connection to remote relay panel of a remote sub-panel 122. Preferably, control system 114 controls electrical circuits 111, 115, and 117 of electrical system 100 during a power outage and/or failure of primary power source 102 through the use of relays (not shown). Control system 114 controls electrical circuits 111, 115, and 117 based on a predetermined priority list established by a user and/or in real-time based on a user's current needs and preferences. Additionally, control system 114 may control as many loads as desired by the user, whereby an electrical system of a dwelling may be comprised of multiple remote panels containing several electrical circuits. Therefore, the control system 114 of the present invention shall not be limited to any one type of electrical system. Conversely, control system 114 shall be able to accommodate any type of electrical system without limiting the spirit of the invention.

Preferably, sensors 116 may be any type of sensor as commonly known in the art, such as, environmental sensors (e.g., ambient temperature sensors, solar sensors, light sensors, etc.), occupancy sensors to determine if a person has entered a room, vital load sensors to determine if a vital load has been activated, etc., which may located throughout the dwelling and coupled to control system 114 via sensor wire 105.

Preferably, disconnect switch/breaker 106 is coupled to transfer switch 108 via electrical wire 104. Transfer switch 108 is preferably coupled to auxiliary power source 109 and main circuit panel 110 via electrical wire 104. Additionally, transfer switch 108 may be coupled to at least one remote sub-panel 118 via electrical wire 104.

Additionally, control system 114 may be coupled to disconnect switch/breaker 106, main circuit panel 110 and at least one sub-panel via electrical wires 104. Furthermore, various configurations of electrical system 100 can be implemented without departing from the spirit of the present invention.

As shown in FIG. 2, illustrated is control system 114 of FIG. 1, whereby the objectives of the invention are achieved by placing a plurality of sensors 202 in a power bus 204, which measures the total current in the bus 204 to the loads 218, 222 and 224 which are then in operation, whereby “n” represents the last load in a system that contains a plurality of loads. Accordingly, “n” indicates that any amount of loads may exist in the system. Sensors 202 may be a conventional utility meter, modified to sense the instantaneous current in the bus and to generate an electronic signal indicating the total current. Alternatively, any current sensor commonly known in the art may be employed as well as a combination of current and voltage sensors, power sensors, and frequency sensors. Importantly, sensors 202 may be utilized to sense each load at the switch side and/or through the power lines (e.g., control wires) of the system. Furthermore, the current indicating signal 203 from sensors 202 is supplied to a logic circuit 206 of a computer or microprocessor. When the current in the power bus 204 exceeds the predetermined threshold of the auxiliary power source, the logic 206 of the microprocessor generates signals 210, 220 and 226, which control current interrupters 212, 214 and 216, which are in series electrical connection with loads 218, 222 and 224, respectively. Preferably, power bus 204 supplies power to interrupters 212, 214 and 216 via electrical wires 205. Logic 206 is programmed to activate the interrupters 212, 214 and 216 so as to shed loads 218, 222 and 224 in a predetermined sequence and/or in real-time as decided by the user when the total current in the power bus 204 exceeds the minimum, middle or the maximum threshold of the auxiliary power source. Preferably, no more than a threshold of 80% of the total power available of the auxiliary power source should be consumed by the active loads, also known as the middle threshold level. Moreover, if the consumption of power by all the active loads reaches or exceeds 95% or the maximum threshold of the total power available of the auxiliary power source, control system 114 begins to shed loads based on a predetermined priority list as determined by the user, a user's current decisions made in real-time, and/or a priority list as determined by the history of the user's usage of loads for the time of day and particular month. Preferably, the minimum threshold value is set to 65% of the total power available of the auxiliary power source. Although particular threshold values were implemented above, it should be appreciated that any threshold level can be implemented without departing from the spirit of the present invention. After shedding sufficient loads to reduce the actual current in the power bus 204 to a point equal to or less than the minimum threshold of the auxiliary power source, logic 206 then determines whether any of the loads which have been shed can be restored to operation without exceeding the middle and/or maximum threshold of the generator power source. If so, that load is automatically restored to operational status and/or restored in real-time based on the current needs of the user.

As shown in FIG. 2, it is contemplated that control system 114 may contain controlled loads 218, 222, and 224 or may manage the controlled loads, which may be located in circuit panels, sub-panels, and/or remote sub-panels via relays. Either method may be implemented without limiting the scope of the present invention.

Periodically logic 206 compares the actual current in power bus 204 with the middle and/or maximum threshold of the auxiliary power source and, when it is possible, the logic restores additional loads to operation. When an operating load is shed, logic 206 measures the value of the load shed. This information is stored in its memory and is used in determining whether the load can be restored during the subsequent periodic re-measurement. As indicated in FIG. 2, the loads or electrical circuits in the dwelling may include uncontrolled loads 208, which control system 114 cannot control, however, whether such uncontrolled loads are present or not, the system will function as described above. Moreover, uncontrolled loads 208 may be coupled to power bus 204 via electrical wire 205.

Additionally and as shown in FIG. 2, control system 114 may be coupled to sensors 230, 232, and 234 via sensor wire 207, whereby “n” represents the last sensor coupled to control system 114. Accordingly, “n” indicates that any amount of sensors may exist in the system without departing from the spirit of the present invention. Furthermore, sensors 230, 232, and 234 may be selected from the following types of sensors, environmental sensors (e.g., ambient temperature sensors, solar sensors, light sensors, etc.), occupancy sensors to determine if a person has entered a room, vital load sensors to determine if a vital load has been activated, etc. These sensors allow the control system of the present invention to effectively monitor and balance all the components of an electrical system during a utility power failure and in accordance to specific needs of the user. Accordingly, control system 114 may activate and deactivate electrical circuits based on information received via sensors 230, 232, and 234 (e.g., upon sensor 230 sensing a temperature of 37 degrees Fahrenheit outside of a dwelling with a hot-tub, control system 114 may be set to activate the load that controls the heater to the hot-tub so as to avoid the pipes from freezing).

Furthermore, control system 114 controls each load of the system through the use of the relays contained within relay panels 120 and 113 (FIG. 1), which are coupled to main circuit panel 110 and sub-panel 112 (FIG. 1), respectively. More specifically, in an attempt to either activate or deactivate a load, control system 114 sends a signal to the appropriate relay, whereby the relay then performs the requested action by making (e.g., activating the load) or breaking (e.g., deactivating the load) the connection from the auxiliary power source to the load.

The energy management system of the present invention provides the user with maximum flexibility in operating the various controlled and uncontrolled devices within the dwelling. Upon installation of the system, the user can program the microprocessor to shed and restore the various controlled loads in any desired sequence, according to the user's priorities if a power outage were to occur. Therefore, the control system will automatically place the devices or more generally the controlled loads in operation whenever there is space for the controlled load of the particular device during a power outage or interruption, whereby the loads are being powered via an auxiliary power source. Conversely, the user may override the preset priority in order to activate or deactivate loads based on the current needs of the user.

Referring now to FIG. 3, illustrated is a front view of a user interactive device 300 in accordance with the present invention. In general, user interactive device 300 is coupled to control system 114. Importantly, user interactive device 300 serves to allow a user in real-time to observe the current settings of the system, status of loads and the status of the backup auxiliary or generator power source as well as control circuits in real-time during an outage.

Generally, user interactive device 300 is a graphical user interface which is preferably a self contained unit and offers particularly, although not exclusively, the following functions: informs the user about the active/inactive status of the circuits within the system, provides visualization of the generator power source current and/or frequency and allows for efficient forcing of circuits in real-time.

Preferably, user interactive device 300 comprises a display 301, a plurality of function keys 302, 304, 306, 308, 310, 312, 314 and 324 and a plurality of directional keys 316, 318, 320 and 322. Display 301 is preferably an LCD screen; however, display 301 of the present invention may be implemented as a CRT, passive LCD, TFT LCD, touch-screen LCD, plasma screen, portable device, or any other user interactive device known in the art without departing from the spirit of the present invention.

As shown in FIG. 3, user interactive device 300 contains function keys 306, 308, 310, 312 and 314, which preferably allow a user to go from one screen to another as user interactive device 300 prompts the user to perform an action. For example, the user may force circuits on and off in real-time via the use of function keys 306, 308, 310, 312 and 314.

Furthermore, display 301 of user interactive device 300 may be capable of displaying various types of information. For example, the main window of display 301 may consist of a total of two bar graphs with numerical displays or a trend graph, a dynamic message field and a navigation function key. Moreover, the bar graphs, trend graphs and numerical display fields preferably serve to indicate the actual current in each phase, the power output and/or load output status of the generator and are preferably located in the center of display 301. Additionally, the dynamic message field preferably serves to indicate, in real-time, the circuits that are active due to the control system 114 and it is preferably located at the bottom of display 301. Control system 114 monitors the auxiliary or generator power source and activates and deactivates the circuits to allow maximum usage of the generator power while avoiding system shutdowns due to generator overload.

Preferably, function key 306 allows a user to navigate to the force review screen, which is generally displayed on the top left of display 301. At the force review screen a user is able to activate a particular circuit in real-time as the user deems necessary. The force review screen consists of a multi-state switch object, dynamic message fields and allows the use of function keys 306, 308, 310, 312 and 314 so that a user may scroll the current screen, navigate away from the screen and perform functions as prompted on display 301. Within the force review screen as shown on display 301 a multi-state switch object is illustrated, which preferably indicates the status (e.g. the ON/OFF state) of the circuit that is being displayed in the selected field indicated by an arrow pointing at the selected circuit, displayed on the right-hand side of the screen. The multi-state switch object will show the status (e.g. the ON/OFF state) of the circuit in real-time. Additionally, the dynamic message fields located on the left side display 301, indicate the circuits controllable by control system 114 (FIG. 1 and FIG. 2). The field indicated by an arrow at the right is the circuit that is currently being analyzed. Preferably, a user may use up, down, left and right direction keys 316, 318, 320 and 322 to navigate through all the circuits and review each circuit in order to determine which circuits are active and which are inactive as well as force on or off specific circuits as desired by the user.

Moreover, display 301 may contain a dynamic message field, which is used to indicate a circuit that is forced ON by placing the letter “F” to indicate that the circuit has been forced ON.

Preferably, display 301 may update the functions that each function key 302, 304, 306, 308, 310, 312, 314 and 324 can perform by displaying the current function in an area within display 301. For example, function key 314 may be used to activate a circuit (e.g. to force a circuit ON) and function key 306 may be used to navigate back to the main screen. If the user would like to activate a circuit (e.g. force a circuit ON), the user preferably presses function key 314 as prompted by display 301, whereby display 301 prompts the user to ensure that the selected circuit is the circuit that the user would like to activate. Thus, a dynamic message field displaying the selected circuit is displayed along with updated functions for function keys 306, 308 and 314. In this particular instance, the user must then press the appropriate function key (e.g., 314, 308 and 306) in order to activate the selected circuit in real-time, deactivate the selected circuit or go to the previous screen, respectively. If the activation of the circuit or changes in other loads causes the auxiliary or generator power source to overload, a message is provided on display 301 indicating that control system 114 has detected an over-current situation and has shut down the loads. Preferably, control system 114 automatically shuts down the loads in a predetermined sequence or by a user deciding in real-time which circuits are to be shed, in order to prevent generator overload and complete generator shutdown. When the generator returns to a stable condition, display 301 indicates that control system 114 has detected a stable current situation within the generator. Preferably, after control system 114 determines that the generator power source is below its middle and/or maximum threshold, control system 114 automatically restores the loads in a predetermined sequence or by a user deciding in real-time which circuits are to be restored.

Additionally, function keys 302, 304 and 324 may be used to perform any type of appropriate function as well as perform various types of functions without departing from the spirit of the present invention.

In one non-limiting embodiment, the system of the present invention comprises at least two sensors and a microprocessor, which serves to measure the current demand in the loads. It is contemplated that the current demands of each load may be measured and/or the total current or total power demand of all the loads and/or loading of the transf01mer (e.g., through frequency measurement) may be measured without limiting the scope of the present invention.

In the preferred embodiment, the present invention is embodied as a system operably interconnected with a utility power source and a generator power source. The control system comprises a plurality of sensors and at least one microprocessor connected to a plurality of loads via a main breaker panel for sensing the current demand of each load present in the system in real-time. In this embodiment, the user may select in real-time which loads are to remain active, which loads are to be shed and which loads are to be restored during an interruption or failure in the utility power source.

Moreover, it is further contemplated that the microprocessor of the present invention may be connected to a third party control system in order to control the loads in the third party control system. In this embodiment, the microprocessor would be able to sense the loads, via any method as discussed above (e.g., sensing current, sensing frequency, etc.), and the user can then make a determination as to which loads should remain active and which loads should be shed in the third party system. Thus, allowing a user to control loads in a third party control system and further allowing the user to create another priority list or possibly to include the user's decisions in a previously established priority list.

The system of the present invention may contain a display (e.g. screen) for interaction with a user and visually displaying the current demand of at least one load within the system. The display may be implemented as a touch-screen LCD, wherein the user is prompted via recorded audio instructions for interaction with the system of the present invention. Alternatively, the user may be prompted during interaction via text instructions shown on the display. The display of the present invention may be implemented as a CRT, passive LCD, TFT LCD, plasma screen, portable device, or any other user interactive device known in the art without departing from the spirit of the present invention.

It will be apparent to those skilled in the art that numerous changes may be made in such details without departing from the spirit and the principles of the invention. It should be appreciated that the present invention is capable of being embodied in various other forms without departing from its essential characteristics.

Importantly, the user interactive device of the present invention is in communication with the control system, through wireless and/or wired means. Thus, the control system of the present invention may have a wireless transmitter in order to transmit messages and alerts to the user interactive device, as well as a wireless receiver which enables an individual to control the control system remotely (e.g. from the user interactive device), and to receive data from the user interactive device of the present invention.

In some locations, the environmental interference (e.g. naturally occurring magnetic fields and waves) may prevent an effective implementation of the present invention via wireless communication means. Accordingly, in an alternate embodiment, the control system of the present invention may be operably interconnected via a wired connection (e.g. electrical wiring, CAT5 wiring, etc.), without departing from the spirit of the present invention.

A variety of different transmission protocols and methods such as cellular, Bluetooth, radio frequency, microwave, infrared, and the like may be used in order to transmit and receive information to and from the user interactive device respectively, without departing from the spirit of the present invention. It will be apparent to those skilled in the art that numerous changes may be made in such details without departing from the spirit and the principles of the invention. It should be appreciated that the present invention is capable of being embodied in various other forms without departing from its essential characteristics.

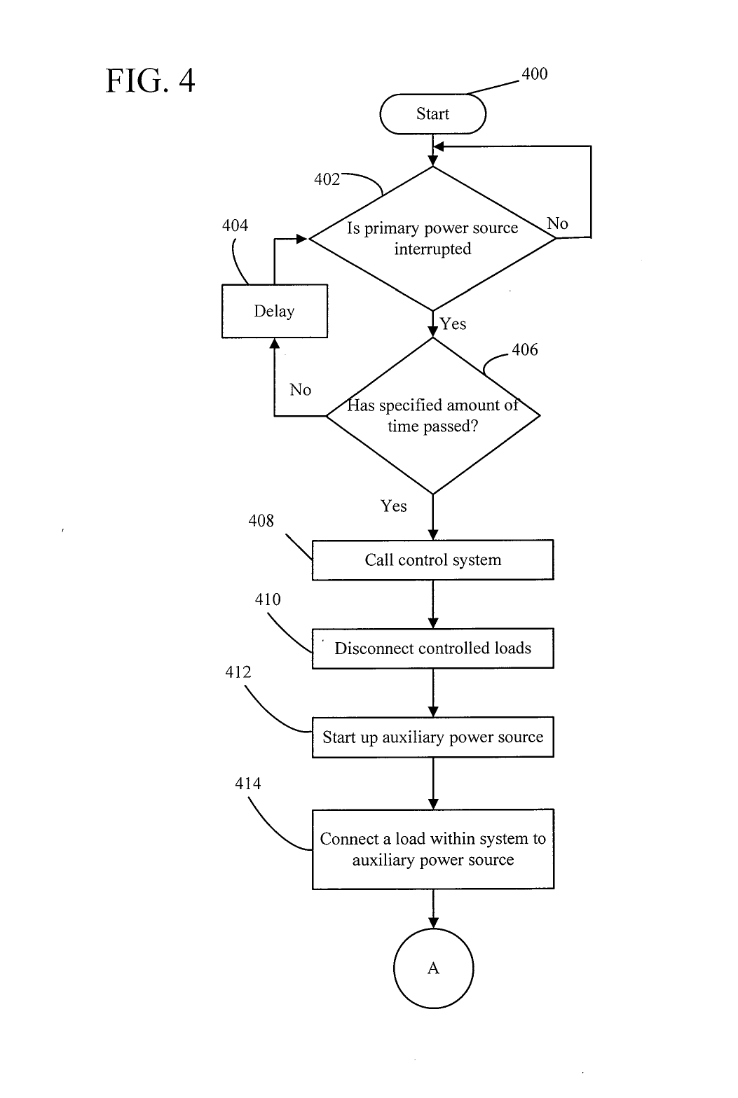

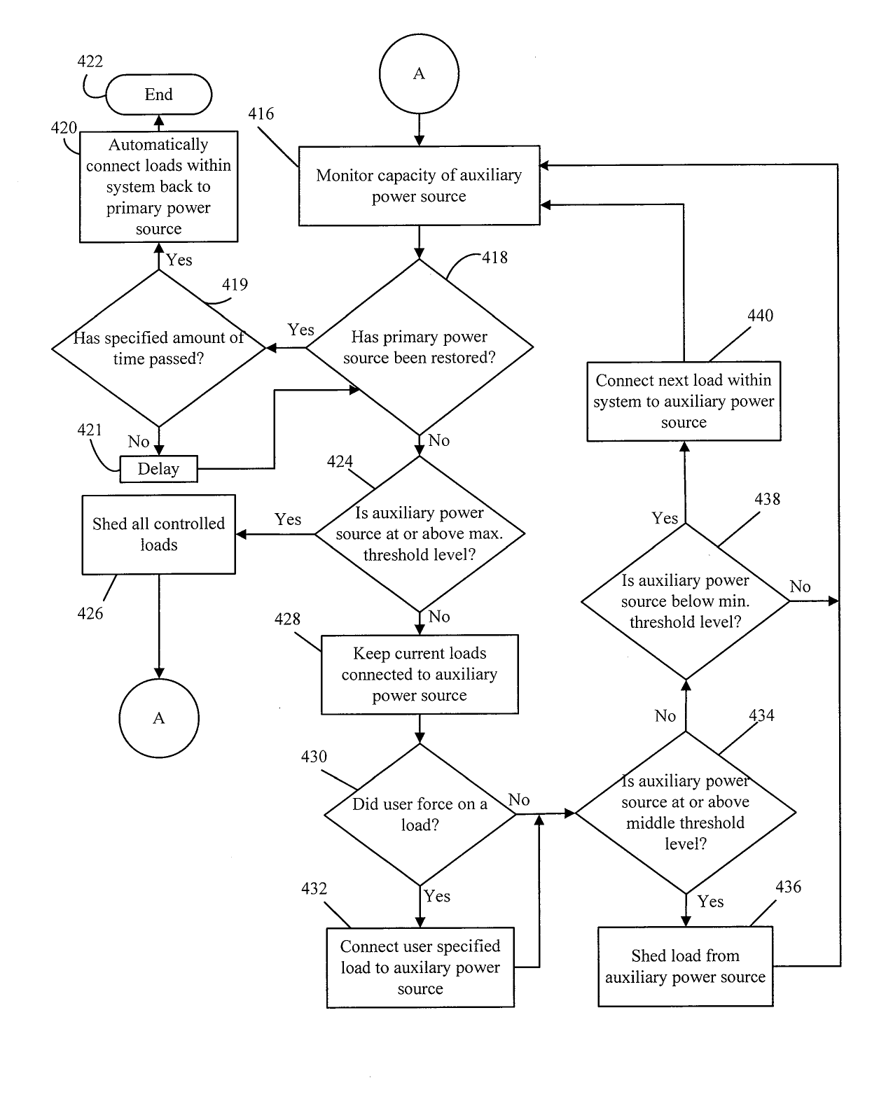

FIG. 4 is flow chart illustrating the method of responding to an interruption in the primary power supplied by the utility power source through the use of a microprocessor in accordance with an embodiment of the present invention. The procedure of FIG. 4 begins in step 400, and proceeds to step 402 where the microprocessor determines if the primary or utility power source has been interrupted. It is also contemplated that a transfer switch as commonly known in the art may be able to determine if the primary power source has been interrupted. If the primary power source has not been interrupted or a power failure has not occurred, the microprocessor is preprogrammed to continuously monitor the primary power source in order to determine a utility power failure in step 402. If the microprocessor has detected an interruption in the utility power source, the microprocessor determines if the appropriate amount of time has passed since first detecting an interruption in the utility power source in step 406. If the appropriate amount of time has not passed, the microprocessor is preprogrammed to wait for a specified amount of time in step 404 before attempting to determine a utility power failure or interruption in step 402. The microprocessor may delay any amount of time before attempting to determine a utility power failure without limiting the scope of the present invention. Once an interruption in the utility power source has been detected consecutively for an appropriate amount of time, the microprocessor transmits a signal to call control system 114 (FIG. 1 and FIG. 2) in step 408 in order to begin the process of activating and deactivating controlled electrical circuits within the system. It should be understood that the microprocessor may continue to detect an interruption in the primary or utility power source for any amount of time before transmitting a signal to call control system (FIG. 1 and FIG. 2) without limiting the scope of the invention. Once the control system has been called, the system disconnects all the controlled loads in step 410.

Next, the system sends a signal to the auxiliary or generator power source in order to power-up the generator power source in step 412. Preferably, once the auxiliary or generator power source achieves the appropriate voltage levels for providing sufficient power to a plurality of loads within the system, the microprocessor automatically switches the source of power being supplied to the loads within the system from the utility power source to the generator power source and begins to connect and activate loads within the system based on a predetermined priority list, and/or real-time decisions based on a user's current preference in step 414. In step 416, control system 114 (FIG. 1 and FIG. 2) monitors the current consumption of power of all the controlled active loads within the system and/or the status of the auxiliary or generator power source with regards to overload, which are being supplied with power by the auxiliary power source so as to increase efficiency and eliminate overloads of the auxiliary power source.

While the loads are connected to the auxiliary power source, the microprocessor determines if the primary or utility power source has been restored at step 418. It is also contemplated that a transfer switch as commonly known in the art may be able to determine if the primary power source has been restored. If the microprocessor determines that the utility power source has been restored, the microprocessor must determine if the utility power source has been restored for a specified amount of time in step 419. Preferably, the microprocessor would also determine if the utility power source has reached the appropriate voltage levels before transferring the loads from the auxiliary power source to the utility power source. If the utility power source has been active for the appropriate amount of time, the system automatically connects the loads back to the primary or utility power source in step 420, where the procedure ends in step 422. However, if the appropriate amount of time has not passed, the microprocessor is preprogrammed to delay for a specified amount of time in step 421 before once again attempting to determine if the utility power source has been restored in step 418. The amount of time required to delay before transferring the loads to the utility power source may be any amount of time as deemed appropriate by someone of skill in the art.

Conversely, if the utility power source has not been restored, all the loads remain connected to the generator power source and the system determines if the auxiliary power source is at or above the maximum threshold level in step 424. If the auxiliary power source is at or above the maximum threshold level, then control system 114 proceeds to shed all the loads in step 426, whereby the system returns back to monitoring the capacity of the auxiliary power source in step 416. If the auxiliary power source is not at or above the maximum threshold level, then control system 114 maintains all the connection of all the loads currently connected to the auxiliary power source in step 428. It is appreciated that loads connected to the auxiliary power source are assumed to be active loads.

Next, control system 114 determines if a user forced on a particular load in real-time via the user interactive device 300 of FIG. 3 in step 430. If it is determined that a user did force on a load in real-time, control system 114 connects the user specified load to the auxiliary power source in step 432. If the user did not force on a load or after control system 114 has forced on a user specified load, control system 114 then determines if the auxiliary power source is at or above the middle threshold level, generally 80% or 85% of total available power, at step 434. If it is determined that collectively all the active loads are drawing power from the auxiliary power source that is at or above the middle threshold level, then control system 114 proceeds to shed a load as determined by a predetermined priority list and/or based on real-time decisions made by the user to accommodate current preferences in step 436, whereby the system returns to step 416 and repeats the process as outlined above.

Meanwhile, if the total power consumed by the active loads is not at or above the middle threshold level of the auxiliary power source, then it is determined if the total power consumed is below the minimum threshold level in step 438. If the total power consumed by all the active loads is not below the minimum threshold level (e.g., 65%), then the system returns to step 416 and repeats the process as outlined above. However, if the auxiliary power source is below the minimum threshold level, control system 114 connects another load within the electrical system to the auxiliary power source in step 440, whereby the next load that is connected to the auxiliary power source is determined by a predetermined priority list and/or based on real-time decisions made by the user to accommodate current preferences. The system then returns to step 416 and repeats the process as outlined above.

Preferably, the process continuously repeats from step 416 until the primary or utility power source has been restored, at which point the system automatically connects the loads back to the primary or utility power source in step 420, where the procedure finally ends in step 422.

It is also contemplated, that the above method outlined in FIG. 4 may include a step that if the user has forced on a load, the control system notifies the user to force another load off so as to not overload the auxiliary power source. This in turn would remove the reliance placed on the control system to shed loads after the user has already forced at least one load on and thus it would avoid exceeding the maximum threshold of the auxiliary power source. As an example, if a user forces on the air conditioner and the auxiliary power source is just below the threshold capacity, forcing the air conditioner on could overload the auxiliary power source before the control system is able to shed enough loads to handle the additional load of the air conditioner due to the lag in response to the suddenly activated load. This step would help to avoid the auxiliary power source from reaching the maximum threshold level or even an overload state, whereby in either situation, the control system will immediately shed every controlled load and subsequently restore each load one by one. In order to implement this step, it would preferably be required to sense and restore the demand of each load within the system and the potential it may have to overload the auxiliary power source upon activation.

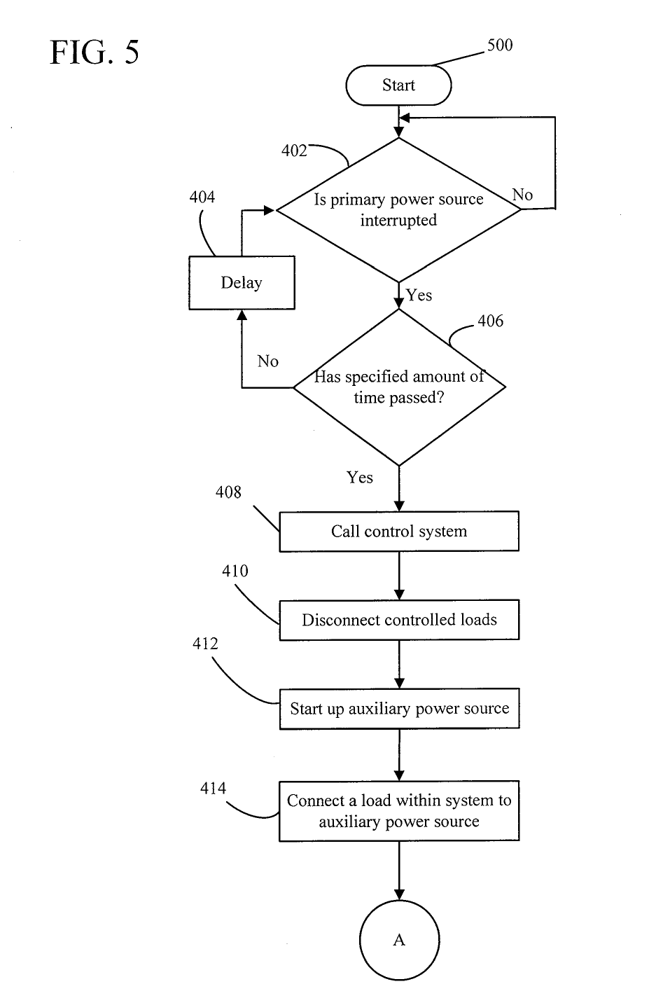

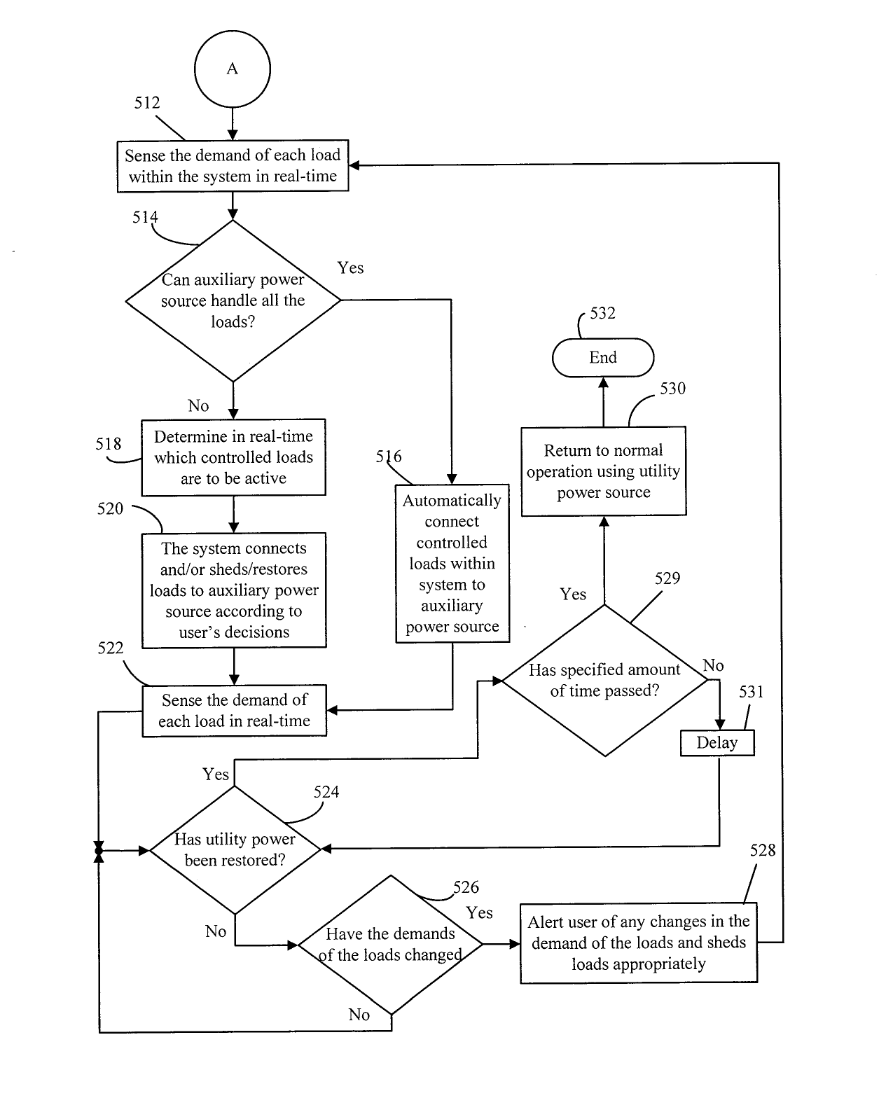

Turning now to FIG. 5, a flow chart illustrates the method in which the microprocessor in conjunction with a user responds to an interruption in the power supplied by a primary source, whereby the auxiliary or generator power source may not be capable of handling all the loads in accordance with an embodiment of the present invention. The process begins in step 500 and proceeds to the same sequence of steps as described above in FIG. 4, which includes steps 402 to 414.

Upon connecting the initial and preferably essential loads to the auxiliary power source, the microprocessor senses the current demand of each load within the system in real-time in step 512. In step 514, the microprocessor subsequently determines if the generator power source is capable of providing power to all the loads that were previously active before the interruption in power occurred based on the current demand of each load previously sensed in real-time. If it has been determined that the generator power source is capable of providing power to all the previously active loads without being overloaded, the microprocessor automatically connects each previously active load to the auxiliary power source in step 516.

However, if the microprocessor has determined that connecting all the currently active loads to the generator power source will overload the generator power source, the microprocessor allows the user to determine in real-time which loads are to remain active, which are to be shed and/or which loads may be restored via the use of a user interactive device in step 518. Subsequently, in step 520 the microprocessor connects and/or restores loads to the auxiliary power source or sheds loads from the auxiliary power source according to the user's decisions.

Once the power supplied to the active loads has been transferred from the utility power source to the generator power source in either step 516 or step 520 based on the criteria described above, the microprocessor once again senses the current demand of each active load in real-time in step 522 and determines if the primary or utility power source has been restored in step 524.

If it is determined that the primary or utility power source has not been restored, it is then determined if the current demand of any of the active loads has changed in step 526. Lf the current demand of the active loads has changed in the system, the microprocessor alerts the user of this change in step 528 and as a precautionary measure may automatically shed loads based on any method previously discussed (i.e., a predetermined priority list, an updated priority list based on past usage, in real-time based on user's preferences, etc.) to ensure that the auxiliary power source does not get overloaded. The microprocessor may alert the user via transmission of an alert signal to the user interactive device or any other device located within the dwelling capable of receiving a signal from the microprocessor. Additionally, the microprocessor may transmit the alert signal via a wireless medium (e.g. cellular, Bluetooth, radio frequency, microwave, infrared, etc.) or via a hard-wired means. Accordingly, the microprocessor may transmit an alert signal to any type of receiving device via any type of commonly known medium in the art without limiting the scope of the present invention.

Upon alerting the user of changes in the current demand of at least one active load in the system, the control system 114 once again senses the demand of each active load within the system in real-time in step 512, whereby the method repeats the procedure as outlined above until the primary or utility power source has recovered from an interruption or has been restored from a utility power failure. Thus, the auxiliary or generator power source continues to supply power to all the active loads as decided by the user in real-time until the microprocessor senses that the utility power source has been restored. However, if the current demands of the active loads have not changed, the microprocessor simply determines if the primary or utility power source has been restored from a power failure or if the utility power source has recovered from the interruption in step 524. Of course the user at any time may shed or restore loads in real-time as desired, whereby the control system 114 will continuously monitor the state of the auxiliary power source to ensure that it does not become overloaded.

Consequently, if the microprocessor determines that the utility power source has been restored, the microprocessor must determine if the utility power source has been restored for a specified amount of time in step 529. Preferably, the microprocessor would also determine if the utility power source has reached the appropriate voltage levels before transferring the loads from the auxiliary power source to the utility power source. If the utility power source has been active for the appropriate amount of time, the electrical system returns back to normal operation, whereby the microprocessor automatically connects the controlled loads of the system back to the primary or utility power source in step 530, where the procedure finally ends in step 532. However, if the appropriate amount of time has not passed, the microprocessor is preprogrammed to delay for a specified amount of time in step 531 before once again attempting to determine if the utility power source has been restored in step 528. The amount of time required to delay before transferring the loads to the utility power source may be any amount of time as deemed appropriate by someone of skill in the art.

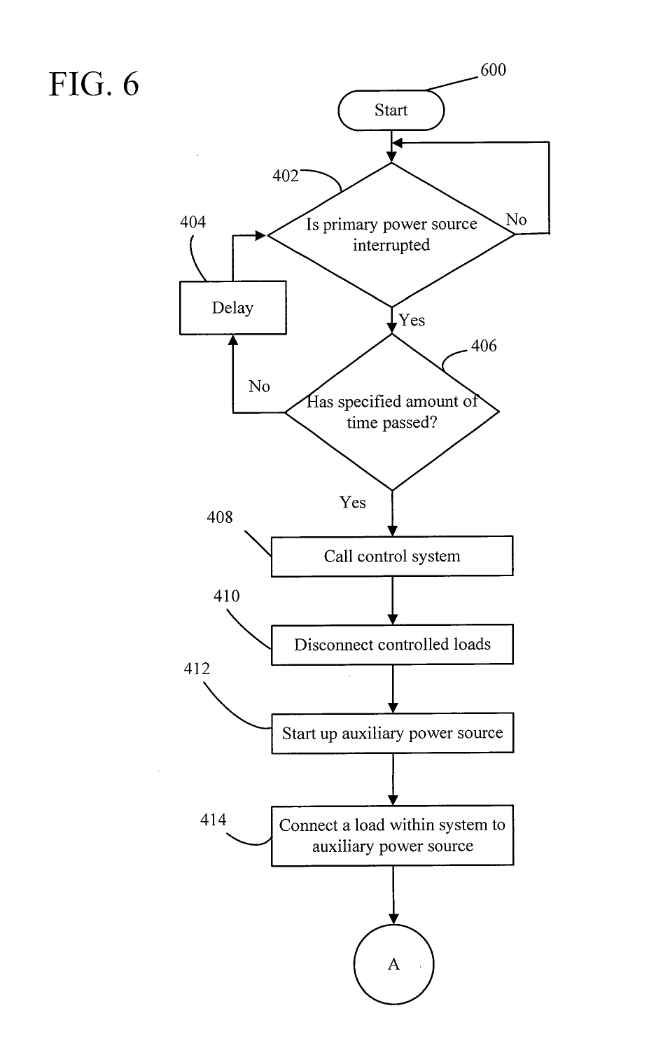

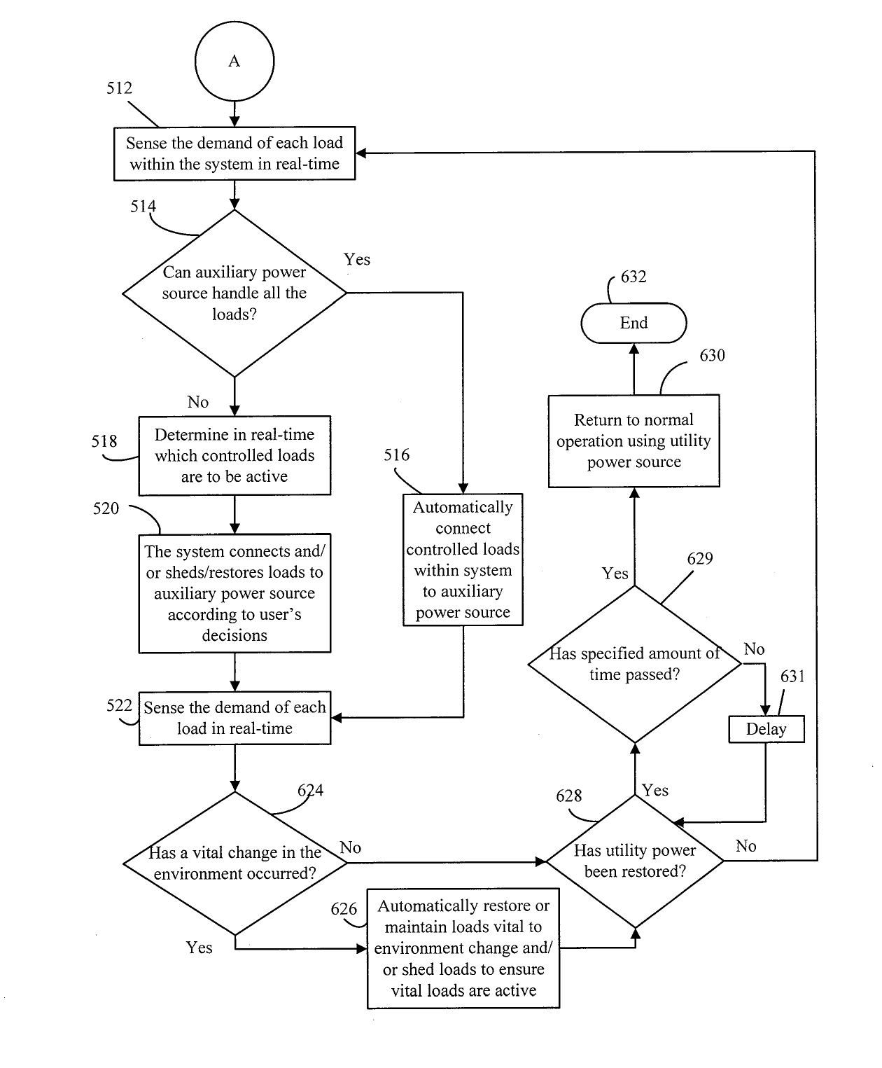

Referring now to FIG. 6, a flow chart illustrates the method in which the microprocessor responds to an interruption in the power supplied by the primary or utility power source, whereby the microprocessor senses a vital change in the environment in accordance with an embodiment of the present invention. The process begins in step 600 and proceeds to the same sequence of steps as described above in FIG. 4, which includes steps 402 to 414.

Preferably, after step 414 is carried out, the process as illustrated in FIG. 6 follows the same or similar method steps as described above in FIG. 5, which includes steps 512 to 522.

Preferably, the microprocessor then senses the environment via the use of sensors 230, 232, and 234 (FIG. 2) in order to determine if a vital change in the environment has occurred in step 624. Generally, a vital change in the environment could be considered when the ambient temperature outside a dwelling with a pool, hot tub, Jacuzzi and the like falls below 37 degrees Fahrenheit, or when the ambient temperature inside a data center rises above 75 degrees Fahrenheit and the like. If the microprocessor has determined that a vital change in the environment has occurred (e.g. the ambient temperature outside a dwelling with a Jacuzzi has fallen below 37 degrees Fahrenheit), the microprocessor automatically restores the load or loads that control the device (e.g. the Jacuzzi heater) that is essential for counteracting the vital change in the environment, if the load or loads were inactive in step 626. However, if the essential load or loads are already active, the microprocessor ensures that the load or loads remain active as long as the vital change in the environment is detected. Importantly, the microprocessor may shed lower priority loads based on predetermined priority or real-time decisions made by the user so as to ensure that the vital loads remain connected and active while the auxiliary or generator power source remains below a threshold value.

Additionally, the user may be notified of the vital change in the environment via transmission of an alert signal to the user interactive device or any other device located within the dwelling capable of receiving a signal from the microprocessor. Furthermore, the microprocessor may transmit the alert signal via a wireless medium (e.g. cellular, Bluetooth, radio frequency, microwave, infrared, etc.) or via a hard-wired means (e.g. CATS wiring, etc.). Accordingly, the microprocessor may transmit an alert signal to any type of receiving device via any type of commonly known medium in the art without limiting the scope of the present invention. Thus, the user may be afforded the opportunity to decide which loads should be shed in real-time in order to ensure the essential load or loads remain active while the vital change in the environment exists.

Upon restoring and/or maintaining the essential load or loads for counteracting the vital change in the environment, the microprocessor determines if the utility power source has been restored from a power failure or if the utility power source has recovered from an interruption in step 628. However, if the microprocessor does not detect a vital change in the environment, the microprocessor simply performs step 628 as described above. If the primary or utility power source has not been restored, control system 114 once again senses the demand of each active load within the system in real-time in step 512, whereby the method repeats the procedure as outlined above until the primary or utility power source has recovered from an interruption or has been restored from a utility power failure. Thus, the auxiliary or generator power source continues to supply power to all the essential loads coupled to the devices that counteract vital changes in the environment as well as to the loads as decided by the user in real-time until the microprocessor senses that the utility power source has been restored.

Consequently, if the microprocessor determines that the utility power source has been restored, the microprocessor must determine if the utility power source has been restored for a specified amount of time in step 629. Preferably, the microprocessor would also determine if the utility power source has reached the appropriate voltage levels before transferring the loads from the auxiliary power source to the utility power source. If the utility power source has been active for the appropriate amount of time, the electrical system returns back to normal operation, whereby the microprocessor automatically connects the controlled loads of the system back to the primary or utility power source in step 630, where the procedure finally ends in step 632. However, if the appropriate amount of time has not passed, the microprocessor is preprogrammed to delay for a specified amount of time in step 631 before once again attempting to determine if the utility power source has been restored in step 628. The amount of time required to delay before transferring the loads to the utility power source may be any amount of time as deemed appropriate by someone of skill in the art.

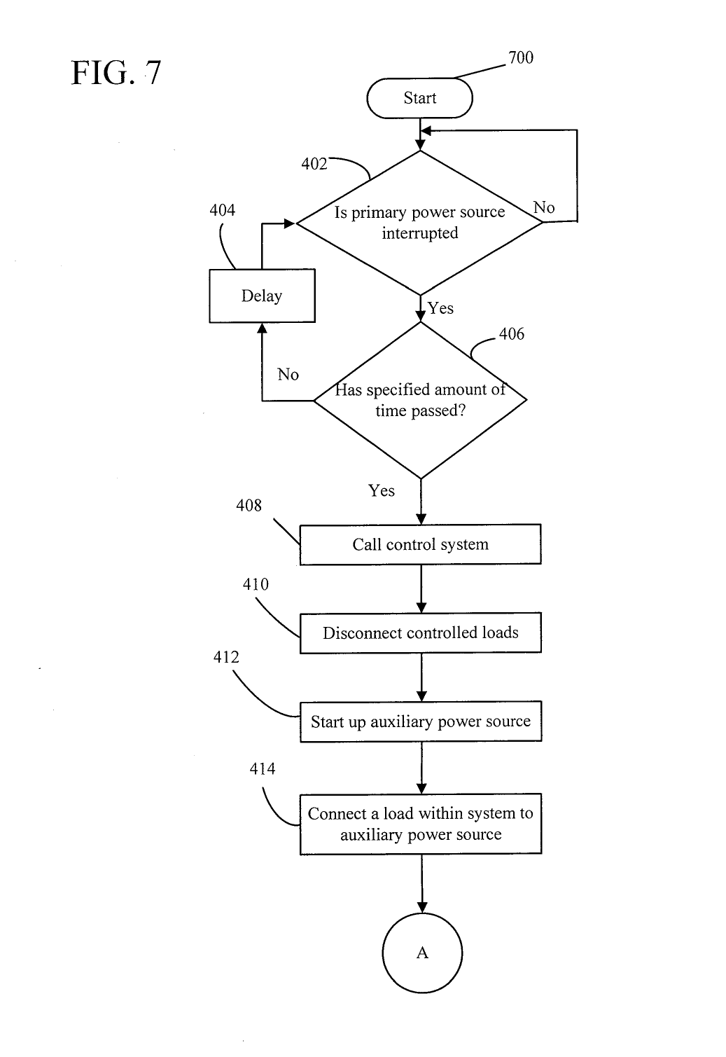

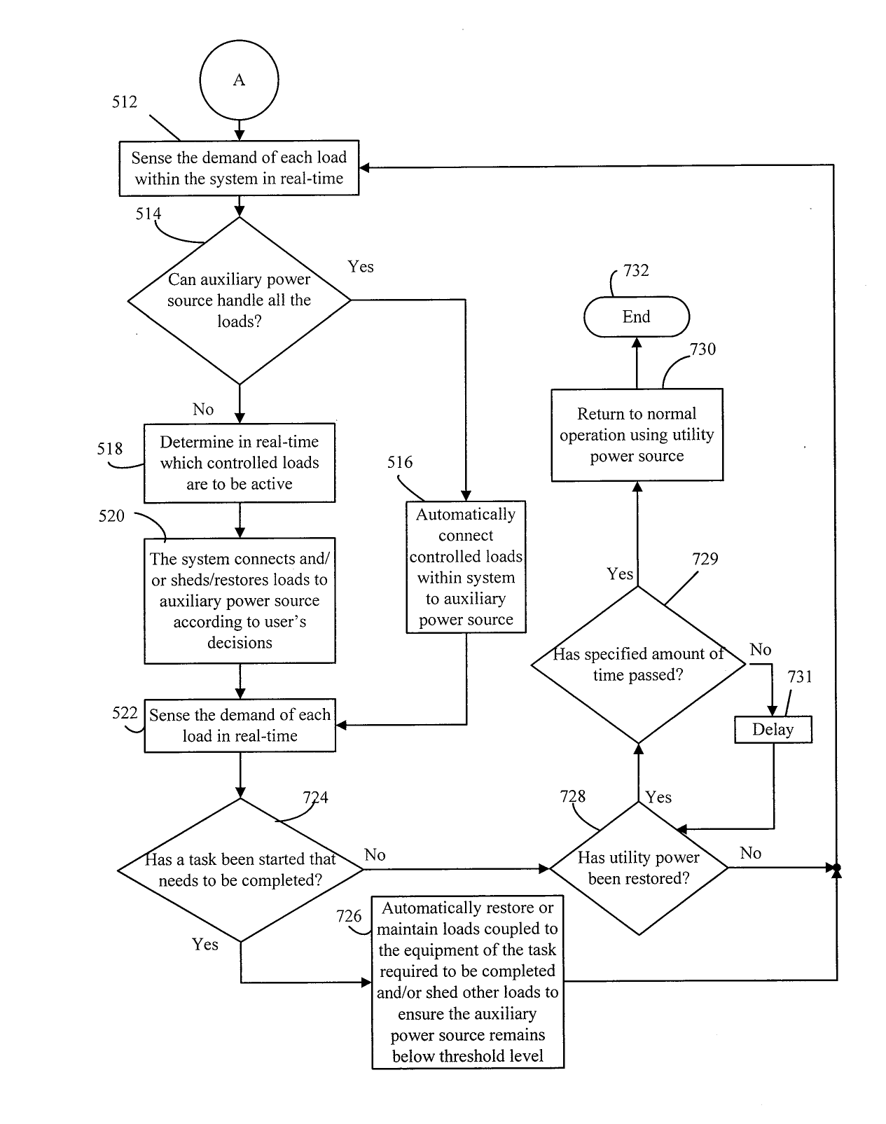

Turning now to FIG. 7, a flow chart illustrates the method in which the microprocessor responds when a process has commenced that must be completed without interruption in accordance with an embodiment of the present invention. The process begins in step 700 and proceeds to the same sequence of steps as described above in FIG. 4, which includes steps 402 to 414.

Preferably, after step 414 is carried out, the process as illustrated in FIG. 7 follows the same or similar method steps as described above in FIG. 5, which includes steps 512 to 522.

Preferably and in step 724, the microprocessor then senses the environment via the use of sensors 230, 232, and 234 (FIG. 2) in order to determine if a task that is currently in progress needs to be completed. A task that when started, which needs to be completed may be particularly, although not exclusively, the process of extracting oil from the ground, a chemical process in a science laboratory, a surgery in a hospital, maintenance of systems in a data center, etc

If a task that needs to be completed is currently in progress and detected, the microprocessor automatically restores the load or loads that control the device (e.g. the drill during an oil drilling expedition) that is essential for completing the task, if the load or loads were inactive in step 726. However, if the essential load or loads are already active, the microprocessor ensures that the load or loads remain active until the task is complete. Importantly, the microprocessor may shed lower priority loads based on predetermined priority or real-time decisions made by the user so as to ensure that the vital loads remain connected and active while the auxiliary or generator power source remains below the middle and/or maximum threshold value.

Additionally, the user may be notified of the task via transmission of an alert signal to the user interactive device or any other device located within the dwelling capable of receiving a signal from the microprocessor. Furthermore, the microprocessor may transmit the alert signal via a wireless medium (e.g. cellular, Bluetooth, radio frequency, microwave, infrared, etc.) or via a hard-wired means (e.g. CATS wiring, etc.). Accordingly, the microprocessor may transmit an alert signal to any type of receiving device via any type of commonly known medium in the art without limiting the scope of the present invention. Thus, the user may be afforded the opportunity to decide which loads should be shed in real-time in order to ensure the essential load or loads remain active while the task is being completed.

Upon restoring and/or maintaining the essential load or loads for completing the necessary task, the microprocessor once again senses the demand of each load within the system in real-time in step 512, whereby the method repeats the procedure as outlined above until it has been determined that the task has been completed.

However, if the microprocessor does not detect a task that must be completed, the microprocessor determines if the utility power source has been restored from a power failure or if the utility power source has recovered from an interruption in step 728. If the primary or utility power source has not been restored, control system 114 once again senses the demand of each active load within the system in real-time in step 512, whereby the method repeats the procedure as outlined above until the primary or utility power source has recovered from an interruption or has been restored from a utility power failure. Thus, the auxiliary or generator power source continues to supply power to the loads as decided by the user in real-time until the microprocessor senses that the primary or utility power source has been restored.

Consequently, if the microprocessor determines that the utility power source has been restored, the microprocessor must determine if the utility power source has been restored for a specified amount of time in step 729. Preferably, the microprocessor would also determine if the utility power source has reached the appropriate voltage levels before transferring the loads from the auxiliary power source to the utility power source. If the utility power source has been active for the appropriate amount of time, the electrical system returns back to normal operation, whereby the microprocessor automatically connects the controlled loads of the system back to the primary or utility power source in step 730, where the procedure finally ends in step 732. However, if the appropriate amount of time has not passed, the microprocessor is preprogrammed to delay for a specified amount of time in step 731 before once again attempting to determine if the utility power source has been restored in step 728. The amount of time required to delay before transferring the loads to the utility power source may be any amount of time as deemed appropriate by someone of skill in the art.

It should be understood that the microprocessor as described and incorporated in FIGS. 4-7 is provided within control system 114 of the present invention. However, some of the steps of the methods described in FIGS. 4-7 may be accomplished by the microprocessor located within automatic transfer switch 108.

From the foregoing description of the preferred embodiments, which have been set forth in considerable detail for the purpose of making a complete disclosure of the present invention, the present invention comprises a control system, comprising at least one sensor, a microprocessor, and a user interactive device.

The key features of the present invention presented above are described for illustrative purposes only and do not serve to limit the scope of the invention to the specific features listed, nor do they represent an exhaustive enumeration of all aspects of the invention. Accordingly, well known methods, procedures, and substances for both carrying out the objectives of the present invention and illustrating the preferred embodiment are incorporated herein but have not been described in detail as not to unnecessarily obscure novel aspects of the present invention.

While the present invention has been described with reference to the key features, preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention.

Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A system for managing power of an auxiliary power source, said system comprising:
a primary power source;
a disconnect switch coupled to said primary power source;
a transfer switch coupled to said disconnect switch;
an auxiliary power source coupled to said transfer switch;
at least one circuit panel coupled to said transfer switch, and coupled to at least one controlled electrical load;
a relay panel having at least one relay, wherein said at least one relay is coupled to said at least one controlled electrical load; and
a control system coupled to said transfer switch for continuously sensing said auxiliary power source, wherein said control system is coupled to said at least one relay in said relay panel for controlling said at least one controlled electrical load thereby managing said auxiliary power source;
wherein said control system sheds or restores said at least one controlled electrical load in via a user interactive device, wherein said user interactive device is associated with or controlled by said user and wherein said user interactive device is remote from the transfer switch.

2. The system according to claim 1, wherein said auxiliary power source is a generator power source, a solar power source, a hydropower source, a wind power source, or a nuclear power source.

3. The system according to claim 1, wherein said primary power source is a utility power source, a solar power source, a hydropower source, a wind power source, or a nuclear power source.

4. The system according to claim 1, further comprising:
a second controlled electrical load coupled to at least one relay within a second relay panel;
at least one sub-panel coupled to said at least one circuit panel, and coupled to said second controlled electrical load, wherein said control system is coupled to said second relay panel for controlling said second controlled electrical load.

5. The system according to claim 1, further comprising:
a third controlled electrical load coupled to at least one relay within a remote relay panel;
at least one remote sub-panel coupled to said transfer switch, and coupled to said third controlled electrical load, wherein said control system is coupled to said remote relay panel for controlling said third controlled electrical load so as to manage said auxiliary power source.

6. The system according to claim 1, wherein said at least one controlled electrical load is coupled to an electrical device.

7. The system according to claim 6, wherein said electrical device is an appliance, a switch, or an outlet.

8. The system according to claim 1, wherein said transfer switch monitors for an interruption in power from a primary power source and switches power received by said at least one controlled electrical load from said primary power source to power received from said auxiliary power source in response to an interruption in power from said primary power source.

9. The system according to claim 8, wherein said transfer switch monitors said primary power source for restoration in power and switches power supplied to said at least one controlled electrical load from said auxiliary power source to said primary power source in response to the restoration in power from said primary power source.

10. The system according to claim 1, wherein said control system senses said power in said auxiliary power source based on the total demand of said at least one controlled electrical load or the frequency of said auxiliary power source.

11. The system according to claim 10, wherein said control system senses a particular level of said power in said auxiliary power source and sheds or restores said at least one controlled electrical load in response to sensing said particular level of said power.

12. The system according to claim 11, wherein said control system sheds or restores said at least one controlled electrical load based on a predetermined priority list.

13. The system according to claim 11, wherein said control system sheds or restores said at least one controlled electrical load in real-time based on a user's current preferences.

14. The system according to claim 11, wherein said control system sheds or restores said at least one controlled electrical load in real-time via a user interactive device, wherein said user interactive device is associated with or controlled by said user.

15. The system according to claim 11, wherein said control system creates a record of said user's history of usage of said at least one controlled electrical load throughout a time period.

16. The system according to claim 15, wherein said control system utilizes said record of said user's history to create an updated priority list, wherein said updated priority list includes actual usage of said at least one controlled electrical load by said user.

17. The system according to claim 16, wherein said control system sheds or restores said at least one controlled electrical load in real-time based on said updated priority list.

18. A method for managing the power supplied to a plurality of controlled electrical loads within a system, the method comprising:
continuously monitoring a connection to a primary power source;
sensing, via a transfer switch, an interruption in power in the primary power source, wherein the transfer switch is coupled to the primary power source via a disconnect switch;
automatically transferring the power supplied to the plurality of controlled electrical loads from the primary power source to an auxiliary power source via the transfer switch, whereby the transfer switch is coupled to the auxiliary power source;
continuously sensing the status of the auxiliary power source via a control system;
detecting the auxiliary power source at a threshold level;
shedding at least one of the plurality of controlled electrical loads from the auxiliary power source via the control system in order to avoid overloading the auxiliary power source wherein said control system sheds at least one controlled electrical load via a user interactive device that is associated with or controlled by said user and wherein said user interactive device is remote from the transfer switch;
restoring at least one of the plurality of controlled electrical loads to the auxiliary power source via the control system;
sensing the restoration of power to the primary power source via the transfer switch; and
automatically transferring the power supplied to the plurality of controlled electrical loads from the auxiliary power source to the primary power source via the transfer switch.

19. The method of claim 18, further comprising:
sensing the power in the auxiliary power source via the control system based on a total demand of the plurality of controlled electrical loads or a frequency of the auxiliary power source.

20. The method of claim 19, further comprising:
alerting the user via the control system that a threshold level of power of the auxiliary power source has been reached, wherein the system allows the user to shed at least one of the plurality of controlled electrical loads based on one of a predetermined priority list, in real-time based on the user's current preferences, or a priority list created from the user's past usage of said at least one controlled electrical load.

21. The method of claim 19, further comprising:
shedding and restoring, dependent upon the status of the auxiliary power source, at least one of the plurality of controlled electrical loads based on a predetermined priority list.

22. The method of claim 19, further comprising:
shedding and restoring, dependent upon the status of the auxiliary power source, at least one of the plurality of controlled electrical loads in real-time based on a user's current preferences.

23. The method of claim 19, further comprising:
shedding and restoring, dependent upon the status of the auxiliary power source, at least one of the plurality of controlled electrical loads in real-time as determined by a user via a user interactive device.

24. The method of claim 19, further comprising:
creating a record of the user's history of usage of the plurality of controlled electrical loads throughout a time period via the control system.

25. The method of claim 24, further comprising:
utilizing the record of the user's history to create an updated priority list, wherein the updated priority list includes the user's actual usage of the plurality of controlled electrical loads.

26. The method of claim 25, further comprising:
shedding and restoring, dependent upon the status of the auxiliary power source, at least one of the plurality of controlled electrical loads in real-time based on the updated priority list.

27. A system for managing an auxiliary power source, said system comprising:
at least one first sensor,
a microprocessor, wherein said microprocessor is coupled to said at least one first sensor;
at least one second sensor coupled to said microprocessor for sensing various conditions;
at least one interrupter coupled to said microprocessor; and
at least one controlled electrical load coupled to said at least one interrupter, wherein said control system sheds and restores said at least one controlled electrical load.

28. The system according to claim 27, wherein said at least one first sensor senses and determines a status of said auxiliary power source in order to determine at least one of the following conditions of said auxiliary power source: the current draw of said auxiliary power source or the frequency of said auxiliary power source.

29. The system according to claim 28, wherein said control system sheds or restores said at least one controlled electrical load based on said status of said auxiliary power source.

30. The system according to claim 29, wherein said control system sheds or restores said at least one controlled electrical load based on one of a predetermined priority list created in real-time based on a user's current preferences, or an updated priority list created from a user's past history of usage of said at least one controlled electrical load.

31. The system according to claim 30, wherein said microprocessor uses data received from said at least one first sensor to send a signal to said at least one interrupter, wherein said at least one interrupter uses said data to shed said at least one controlled electrical load.

32. The system according to claim 30, wherein said microprocessor uses data received from said at least one first sensor to send a signal to said at least one interrupter, wherein said at least one interrupter uses said data to restore said at least one controlled electrical load.

33. The system according to claim 28, wherein said at least one second sensor senses one of an environmental condition, an occupancy condition, or an activation of vital electrical load condition.

34. The system according to claim 33, wherein said sensed environmental condition consists of a temperature, a solar light, or an ambient light.

35. The system according to claim 34, wherein said microprocessor uses data received from said at least one second sensor to send a signal to said at least one interrupter, wherein said at least one interrupter uses said data to shed at least one controlled electrical load.

36. The system according to claim 35, wherein said microprocessor uses data received from said at least one second sensor to send a signal to said at least one interrupter, wherein said at least one interrupter uses said data to restore at least one controlled electrical load.

37. The system according to claim 28, wherein said at least one controlled electrical load is shed in real-time via a user interactive device.

38. The system according to claim 28, wherein said at least one controlled electrical load is restored in real-time via a user interactive device.

39. A method for managing power supplied to a plurality of controlled electrical loads within a system, the method comprising:
continuously monitoring a connection to a primary power source;
sensing, via a transfer switch, an interruption in the connection to the primary power source, wherein the transfer switch is coupled to the primary power source via a disconnect switch;
automatically transferring, via the transfer switch, power received by the plurality of controlled electrical loads from the primary power source to an auxiliary power source, wherein the transfer switch is coupled to the auxiliary power source;
continuously sensing the status of the auxiliary power source via a control system wherein the control system is accessible via a user interactive device, wherein said user interactive device is associated with or controlled by said user and wherein said user interactive device is remote from the transfer switch;
detecting a vital change in the environment via a sensor, wherein the sensor is coupled to said control system;
maintaining a controlled electrical load necessary for stabilizing the vital change; and
managing the auxiliary power source via the control system.

40. The method of claim 39, further comprising:
managing the plurality of controlled electrical loads by shedding at least one of the plurality of controlled electrical loads from the auxiliary power source in order to avoid overloading the auxiliary power source.

41. The method of claim 40, further comprising:
managing the plurality of controlled electrical loads by restoring at least one of the plurality of controlled electrical loads to the auxiliary power source.

42. The method of claim 41, further comprising:
shedding or restoring at least one of the plurality of controlled electrical loads based on one of a predetermined priority list, the user's current preferences in real-time, or a priority list created from the user's past usage of said at least one controlled electrical load.

43. A method for managing power supplied to a plurality of controlled electrical loads within a system, the method comprising:
continuously monitoring a connection to a primary power source;
sensing, via a transfer switch, the connection to the primary power source, wherein the transfer switch is coupled to the primary power source via a disconnect switch;
automatically transferring, via the transfer switch, the power received by the plurality of controlled electrical loads from the primary power source to an auxiliary power source, wherein the transfer switch is coupled to the auxiliary power source;
continuously sensing the status of the auxiliary power source via a control system;
detecting a task, which requires completion, via a sensor coupled to said control system;
maintaining a controlled electrical load necessary for completing the task; and
managing the auxiliary power source via the control system by using a user interactive device, wherein said user interactive device is associated with or controlled by said user and wherein said user interactive device is remote from the transfer switch.

44. The method of claim 43, further comprising:
managing the plurality of controlled electrical loads by shedding at least one of the plurality of controlled electrical loads from the auxiliary power source in order to avoid overloading the auxiliary power source.

45. The method of claim 44, further comprising:
managing the plurality of controlled electrical loads by restoring at least one of the plurality of controlled electrical loads to the auxiliary power source.

46. The method of claim 45, further comprising:
shedding and restoring at least one of the plurality of controlled electrical loads based on one of a predetermined priority list, the user's current preferences in real-time, or a priority list created from the user's past usage of said at least one controlled electrical load.

47. The system according to claim 1, wherein said control system comprises:
at least one first sensor;
a microprocessor, wherein said microprocessor is coupled to said at least one first sensor;
at least one second sensor coupled to said microprocessor for sensing various conditions;
at least one interrupter coupled to said microprocessor; and
at least one controlled electrical load coupled to said at least one interrupter, wherein said control system is capable of shedding and restoring said at least one controlled electrical load.

48. The system according to claim 47, wherein said at least one first sensor senses and determines a status of said auxiliary power source in order to determine at least one of the following conditions of said auxiliary power source: the current draw of said auxiliary power source or the frequency of said auxiliary power source.

49. The system according to claim 48, wherein said control system sheds or restores said at least one controlled electrical load based on said status of said auxiliary power source.

50. The system according to claim 49, wherein said control system sheds or restores said at least one controlled electrical load based on one of a predetermined priority list created in real-time based on a user's current preferences, or an updated priority list created from a user's past history of usage of said at least one controlled electrical load.

51. The system according to claim 48, wherein said at least one second sensor senses one of an environmental condition, an occupancy condition, or an activation of vital electrical load condition.

52. The system according to claim 51, wherein said microprocessor uses data received from said at least one second sensor to send a signal to said at least one interrupter, wherein said at least one interrupter uses said data to shed or restore at least one controlled electrical load.

53. The system according to claim 48, wherein said at least one controlled electrical load is shed or restored in real-time via a user interactive device.
